(19) United States
(12) Patent Application Publication
(10) Pub. No.: US 2013/0147979 A1
(43) Pub. Date: Jun. 13, 2013

(54) SYSTEMS AND METHODS FOR EXTENDING DYNAMIC RANGE OF IMAGER ARRAYS BY CONTROLLING PIXEL ANALOG GAIN

(71) Applicant: PELICAN IMAGING CORPORATION, Mountain View, CA (US)

(72) Inventors: Andrew Kenneth John McMahon, Menlo Park, CA (US); Paul Gallagher, San Jose, CA (US); Kartik Venkataraman, San Jose, CA (US)

(73) Assignee: PELICAN IMAGING CORPORATION, Mountain View, CA (US)

(21) Appl. No.: 13/761,040

(22) Filed: Feb. 6, 2013

Related U.S. Application Data
(63) Continuation-in-part of application No. 13/106,797, filed on May 12, 2011.
(60) Provisional application No. 61/334,011, filed on May 12, 2010.
(60) Provisional application No. 61/595,611, filed on Feb. 6, 2012.

(51) Int. Cl. H04N 5/335

(52) U.S. Cl. CPC H04N 5/335
USPC 348/218.1

(57) ABSTRACT

Array cameras and imager arrays configured to capture high dynamic range light field image data and methods of capturing high dynamic range light field image data in accordance with embodiments of the invention are disclosed. Imager arrays in accordance with many embodiments of the invention include multiple focal planes with associated read out and sampling circuitry. The sampling circuitry controls the conversion of the analog image information into digital image data. In certain embodiments, the sampling circuitry includes an Analog Front End (AFE) and an Analog to Digital Converter (ADC). In several embodiments, the AFE is used to apply different amplification gains to analog image information read out from pixels in a given focal plane to provide increased dynamic range to digital image data generated by digitizing the amplified analog image information. The different amplifications gains can be applied in a predetermined manner or on a pixel by pixel basis.

This application claims priority as a Continuation-In-Part application of U.S. patent application Ser. No. 13/106,797, filed May 12, 2011, which claims the benefit of U.S. Provisional Patent Application Ser. No. 61/334,011 filed on May 12, 2010. This application also claims priority under 35 U.S.C. §119(e) to U.S. Provisional Application Ser. No. 61/595,611 filed Feb. 6, 2012. The disclosures of U.S. patent application Ser. No. 13/106,797 and U.S. Provisional Patent Application Ser. Nos. 61/334,011 and 61/595,611 are incorporated by reference herein in their entirety.

### FIELD OF THE INVENTION

The present invention relates generally to imagers and more specifically to imager arrays used in array cameras.

### BACKGROUND OF THE INVENTION

Researches have used multiple cameras or a camera array spanning a wide synthetic aperture to capture light field images (e.g. the Stanford Multi-Camera Array). A light field, which is often defined as a 4D function characterizing the light from all direction at all points in a scene, can be interpreted as a two-dimensional (2D) collection of 2D images of a scene. Due to practical constraints, it is typically difficult to simultaneously capture the collection of 2D images of a scene that form a light field. However, the closer in time at which the image data is captured by each of the cameras, the less likely that variations in light intensity (e.g. the otherwise imperceptible flicker of fluorescent lights) or object motion will result in time dependent variations between the captured images. Processes involving capturing and resampling a light field can be utilized to simulate cameras with large apertures. For example, an array of M×N cameras pointing at a scene can simulate the focusing effects of a lens as large as the array. Use of camera arrays in this way can be referred to as synthetic aperture photography.

A sensor used in a conventional single focal plane camera, typically includes a row controller and one or more column read-out circuits. In the context of the array of pixels in an imager, the term “row” is typically used to refer to a group of pixels that share a common control line(s) and the term “column” is a group of pixels that share a common read-out line(s). A number of array camera designs have been proposed that use either an array of individual cameras/sensors or a lens array focused on a conventional single focal plane sensor. When multiple separate cameras are used in the implementation of an array camera, each camera has a separate I/O path and the camera controllers are typically required to be synchronized in some way. When a lens array focused on a single focal plane sensor is used to implement an array camera, the sensor is typically a conventional sensor similar to that used in a conventional camera. As such, the sensor does not possess the ability to independently control the pixels within the image circle of each lens in the lens array.

### SUMMARY OF THE INVENTION

Systems and methods are disclosed in which an imager array including an array of focal planes and configured to capture high dynamic range light field image data by applying different amplification gains to analog image information read out from pixels in a given focal plane of the imager array is implemented as a monolithic integrated circuit in accordance with embodiments of the invention. In many embodiments, the imager array includes a plurality of focal planes that are each independently controlled by control logic within the imager array and the image data captured by each imager is output from the imager array using a common I/O path. In a number of embodiments, the imager array is configured to capture high dynamic range light field image data by applying different amplification gains to analog image information read out from pixels in a given focal plane of the imager array. The different amplification gains can be applied to analog image information read out from individual pixels in a given focal plane. Different amplification gains can be applied to analog image information read out from subsets of pixels from a given focal plane. In addition, the amplification gain applied to the analog image information read out from pixels in a given focal plane can be determined on a pixel by pixel basis based upon the output value of analog image information read out from a pixel. In several embodiments, a camera module can be constructed using an imager array configured to capture high dynamic range light field image data by applying different amplification gains to analog image information read out from pixels in a given focal plane of the imager array and an optic array of lens stacks. In many embodiments, an array camera can be constructed from a camera module including an imager array configured to capture high dynamic range light field image data by applying different amplification gains to analog image information read out from pixels in a given focal plane of the imager array and an optic array of lens stacks, and a processor configured to communicate with the imager array. In certain embodiments, the processor is configured to synthesize high resolution images from the high dynamic range light field image data captured by the imager array using a super-resolution process.

One embodiment includes a plurality of focal planes, where each focal plane comprises a plurality of rows of pixels that also form a plurality of columns of pixels and each focal plane is contained within a region of the imager array that does not contain pixels from another focal plane; read out circuitry configured to independently read out analog image information from pixels in the plurality of focal planes; sampling circuitry configured to covert the analog image information read out from pixels in a given focal plane into high dynamic range digital image data, where the sampling circuitry for a given focal plane includes an Analog Front End configured to apply a plurality of different amplification gains to analog image information read out from different pixels in the given focal plane to produce amplified high dynamic range analog image information, and an Analog to Digital Converter configured to convert the amplified high dynamic range analog image information into high dynamic range digital image data; and interface circuitry configured to transmit high dynamic range digital image data to an external device.

In a further embodiment, the Analog Front End comprises at least two Analog Front End processing channels; the sampling circuitry is configured so that a first Analog Front End processing channel applies a first predetermined amplification gain to analog image information read out from a pixel from the given focal plane; and the sampling circuitry is configured so that a first Analog Front End processing channel applies a second predetermined amplification gain that is less than the first predetermined amplification gain to analog image information read out from a pixel from the given focal plane.

In another embodiment, the Analog Front End is configured to apply a plurality of different amplification gains to analog image information read out from different pixels in the given focal plane to produce amplified high dynamic range analog image information such that a higher amplification gain is applied to analog image information read out from a pixel that has an output value that satisfies a low light threshold and a lower amplification gain is applied to analog image information read out from a pixel that has an output value that does not satisfy the low light threshold.

In a still further embodiment, high dynamic range digital image data for a pixel in the given focal plane includes a plurality of bits determined by digitizing amplified high dynamic range analog image information using the Analog to Digital Converter, where the amplified high dynamic range analog information is obtained by applying an amplification gain from the plurality of different amplification gains to analog image information read out from the pixel, and at least one bit indicative of the amplification gain from the plurality of different amplification gains applied to the analog image information read out from the pixel to obtain the high dynamic range analog image data.

In still another embodiment, the Analog Front End includes a first analog amplifier configured to amplify analog image information using a first amplification gain, and a second analog amplifier configured to amplify analog image information using a second amplification gain, where the second amplification gain is less than the first amplification gain.

A yet further embodiment, also includes control circuitry configured to provide analog image information read out from a pixel that has an output value that satisfies a low light threshold to the first analog amplifier and to provide analog image information read out from a pixel that has an output value that does not satisfy the low light threshold to the second analog amplifier.

In yet another embodiment, the control circuitry comprises at least one comparator configured to determine whether an output value of analog image information read out from a pixel is below a low light threshold value.

In a still yet further embodiment, high dynamic range digital image data for a pixel in the given focal plane includes a plurality of bits determined by digitizing amplified high dynamic range analog image information using the Analog to Digital Converter, where the amplified high dynamic range analog information is obtained by applying an amplification gain from the plurality of different amplification gains to analog image information read out from the pixel, and at least one bit indicative of the amplification gain from the plurality of different amplification gains applied to the analog image information read out from the pixel to obtain the high dynamic range analog image data.

In still yet another embodiment, the Analog Front End comprises an analog amplifier configured to amplify analog image information using an amplification gain selected from the plurality of different amplification gains on a pixel by pixel basis by control circuitry.

In another embodiment again, the control circuitry is configured to control the selection of an amplification gain from the plurality of different amplification gains for use by the analog amplifier in amplifying analog image information in a predetermined manner.

In a further embodiment again, the control circuitry is configured to select a first amplification gain from the plurality of different amplification gains for use by the analog amplifier when the analog image information read out from a pixel has an output value that satisfies a low light threshold, and the control circuitry is configured to select a second amplification gain that is less than the first amplification gain from the plurality of different amplification gains for use by the analog amplifier when the analog image information read out from a pixel has an output value that does not satisfy a low light threshold.

In another embodiment again, the control circuitry comprises at least one comparator configured to determine whether an output value of analog image information read out from a pixel is below a low light threshold value.

In a further additional embodiment, high dynamic range digital image data for a pixel in the given focal plane includes a plurality of bits determined by digitizing amplified high dynamic range analog image information using the Analog to Digital Converter, where the amplified high dynamic range analog information is obtained by applying an amplification gain from the plurality of different amplification gains to analog image information read out from the pixel, and at least one bit indicative of the amplification gain from the plurality of different amplification gains applied to the analog image information read out from the pixel to obtain the high dynamic range analog image data.

In a still further embodiment again, the pixels of the given focal plane have the same conversion gain.

In still another embodiment again, the pixels of the given focal plane have different conversion gains.

In a yet further embodiment again, the Analog Front End is dedicated to the given focal plane.

In yet another embodiment again, the Analog Front End is shared by the given focal plane and at least one additional focal plane.

In a still further additional embodiment, the Analog Front End comprises a plurality of Analog Front End processing channels and the sampling circuitry is configured so that each Analog Front End processing channel applies an amplification gain selected from the plurality of different amplification gains to analog image information read out from a subset of pixels from the given focal plane.

In still another additional embodiment, the Analog Front End comprises a plurality of Analog Front End processing channels and the sampling circuitry is configured so that each Analog Front End processing channel applies a different amplification gain from the plurality of different amplification gains to analog image information read out from a pixel from the given focal plane.

In a yet further additional embodiment, each Analog Front End processing channel includes a dedicated ADC.

In yet another additional embodiment, the Analog to Digital Converter (ADC) is configured to convert the amplified high dynamic range analog image information into high dynamic range digital image data by quantizing the amplified high dynamic range analog image information.

Another further embodiment also includes calibration circuitry. In addition, the Analog Front End is configured to apply the plurality of different amplification gains to calibration information read out from at least one black pixel, the calibration circuitry can determine a black level offset level for each of the plurality of different amplification gains applied by the Analog Front End to analog image information read out from active pixels in the given focal plane, and the calibration circuitry is configured to apply a black level offset to the amplified high dynamic range analog image information prior to conversion to high dynamic range digital image data by the Analog to Digital Converter.

Still another further embodiment also includes calibration circuitry. In addition, the Analog Front End is configured to apply the plurality of different amplification gains to calibration information read out from at least one black pixel, the calibration circuitry can determine a black level offset level for each of the plurality of different amplification gains applied by the Analog Front End to analog image information read out from active pixels in the given focal plane, and the calibration circuitry is configured to apply a black level offset to the high dynamic range digital image data output by the Analog to Digital Converter.

Yet another further embodiment includes a plurality of focal planes, where each focal plane comprises a plurality of rows of pixels that also form a plurality of columns of pixels and each focal plane is contained within a region of the imager array that does not contain pixels from another focal plane, read out circuitry configured to independently read out analog image information from pixels in the plurality of focal planes, sampling circuitry configured to covert the analog image information read out from pixels in a given focal plane into digital image data, where the sampling circuitry for a given focal plane includes an Analog Front End (AFE) configured to apply an amplification gain selected from a plurality of different amplification gains to analog image information read out from different pixels in the given focal plane to produce amplified analog image information, an Analog to Digital Converter (ADC) configured to convert the amplified analog image information into digital image data, and control circuitry configured to configure the sampling circuitry in a mode selected from a group consisting of at least a standard image capture mode and a high dynamic range image capture mode in response to a configuration command; and interface circuitry configured to: transmit digital image data to an external device; receive a configuration command from an external device; and provide a configuration command received from an external device to the control circuitry. In addition, the sampling circuitry is configured so that the Analog Front End applies the same amplification gain to the analog image information read out from the pixels in the given focal plane in the standard image capture mode, and the sampling circuitry is configured so that the Analog Front End applies different amplification gains selected from the plurality of different amplification gains to the analog image information read out from the pixels in the given focal plane in the high dynamic range image capture mode.

In still yet another further embodiment, the sampling circuitry is configured so that the AFE applies different amplification gains selected from the plurality of different amplification gains to the analog image information read out from the pixels in the given focal plane in the high dynamic range image capture mode so that a higher amplification gain is applied to analog image information read out from a pixel that has an output value that satisfies a low light threshold and a lower amplification gain is applied to analog image information read out from a pixel that has an output value that does not satisfy a low light threshold.

In another further additional embodiment, the digital image data in the high dynamic range mode is high dynamic range digital image data and high dynamic range digital image data for a pixel in the given focal plane includes: a plurality of bits determined by digitizing amplified high dynamic range analog image information using the Analog to Digital Converter, where the amplified high dynamic range analog information is obtained by applying an amplification gain from the plurality of different amplification gains to analog image information read out from the pixel; and at least one bit indicative of the amplification gain from the plurality of different amplification gains applied to the analog image information read out from the pixel to obtain the high dynamic range analog image data.

An embodiment of the method of the invention includes capturing analog image information for a light field using a plurality of active focal planes in a camera module comprising an imager array and an optic array of lens stacks, where each focal plane comprises a plurality of rows of pixels that also form a plurality of columns of pixels and each focal plane is contained within a region of the imager array that does not contain pixels from another focal plane, and where the imager array further includes: read out circuitry configured to independently read out analog image information from pixels in the plurality of focal planes; and sampling circuitry configured to covert the analog image information read out from pixels in a given focal plane into high dynamic range digital image data. In addition, the sampling circuitry for a given focal plane includes an Analog Front End configured to apply a plurality of different amplification gains to analog image information read out from different pixels in the given focal plane to produce amplified high dynamic range analog image information, and an Analog to Digital Converter configured to convert the amplified high dynamic range analog image information into high dynamic range digital image data. Furthermore, an image is formed on each active focal planes by a separate lens stack in said optic array of lens stacks. The method further including selecting a plurality of pixels from at least one row and at least one column in a given focal plane from the plurality of active focal planes using the read out circuitry and reading out analog image information from the selected pixels in the given focal plane, amplifying the analog image information read out from the selected pixels in the given focal plane using amplification gains selected from the plurality of different amplification gains using the Analog Front End to produce amplified high dynamic range analog image information for the selected pixel in the given focal plane, converting the amplified high dynamic range analog image information for the selected pixels in the given focal plane into high dynamic range digital image data for the selected pixels in the given focal plane using the Analog to Digital Converter, and transmitting from the camera module image data including the high dynamic range digital image data.

In a further embodiment of the method of the invention, amplifying the analog image information read out from the selected pixels in the given focal plane using amplification gains selected from the plurality of different amplification gains using the Analog Front End to produce amplified high dynamic range analog image information for the selected pixel in the given focal plane further includes applying a first amplification gain from the plurality of different amplification gains to analog image information read out from a pixel, and applying a second amplification gain that is less than the first amplification gain to analog image information read out from a pixel.

In another embodiment of the method of the invention, amplifying the analog image information read out from the selected pixels in the given focal plane using amplification gains selected from the plurality of different amplification gains using the Analog Front End to produce amplified high dynamic range analog image information for the selected pixel in the given focal plane further includes applying a first amplification gain from the plurality of different amplification gains to analog image information read out from a pixel that has an output value that satisfies a low light threshold, and applying a second amplification gain that is less than the first amplification gain to analog image information read out from a pixel that has an output value that does not satisfy the low light threshold.

In a still further embodiment of the method of the invention, converting the amplified high dynamic range analog image information for the selected pixels in the given focal plane into high dynamic range digital image data for the selected pixels in the given focal plane using the Analog to Digital Converter further comprises generating high dynamic range digital data for a selected pixel by: generating a plurality of image data bits determined by digitizing amplified high dynamic range analog image information using the Analog to Digital Converter, where the amplified high dynamic range analog information is obtained by applying an amplification gain from the plurality of different amplification gains to analog image information read out from the selected pixel; and generating at least one bit of additional data, where the at least one bit of additional data is indicative of the amplification gain from the plurality of different amplification gains applied to the analog image information read out from the selected pixel to obtain the high dynamic range analog image data; and combining the plurality of image data bits and the at least one bit of additional data to create high dynamic range digital image data for the selected pixel.

### BRIEF DESCRIPTION OF THE DRAWINGS

FIG. 1 is a block diagram of an array camera in accordance with an embodiment of the invention.

FIG. 1A conceptually illustrates the construction of an array camera module in accordance with an embodiment of the invention.

FIG. 1B is a block diagram of a monolithic imager array in accordance with an embodiment of the invention.

FIGS. 2A and 2B illustrate imager configurations of imager arrays in accordance with embodiments of the invention.

FIG. 3 illustrates an architecture of an imager array in accordance with an embodiment of the invention.

FIG. 4 illustrates another architecture of an imager array including shared analog to digital converters in accordance with an embodiment of the invention.

FIG. 4A illustrates a further architecture of an imager array including shared column circuits in accordance with an embodiment of the invention.

FIG. 4B illustrates still another architecture of an imager array including shared split column circuits in accordance with an embodiment of the invention.

FIG. 4C illustrates the phase shifting of column circuit outputs from two focal planes read-out in accordance with an embodiment of the invention.

FIG. 4D illustrates a pair of focal planes in an imager array having dedicated Analog Front End (AFE) circuitry and sharing an Analog to Digital Converter (ADC) in accordance with an embodiment of the invention.

FIG. 4E illustrates a group of four focal planes in an imager array where pairs of focal planes share AFE circuitry and the group of four focal planes share an ADC in accordance with an embodiment of the invention.

FIG. 4F illustrates a pair of focal planes within an imager array where the pair of focal planes share column control read-out circuitry in accordance with an embodiment of the invention.

FIG. 4G illustrates a pair of focal planes within an imager array where the column control and read-out circuitry is split and a single block of column control and read-out circuitry reads out odd columns from a first focal plane and even columns from a second focal plane in accordance with an embodiment of the invention.

FIG. 4H is a block diagram illustrating focal plane timing and control circuitry in accordance with an embodiment of the invention.

FIG. 4I illustrates a focal plane with a dedicated AFE and ADC configured to generate high dynamic range image data in accordance with an embodiment of the invention.

FIG. 4J illustrates a focal plane with a dedicated AFE including multiple AFE channels and a dedicated ADC, where the AFE and ADC are configured to generate high dynamic range image data in accordance with an embodiment of the invention.

FIG. 4JA illustrates a focal plane including a dedicated AFE including two AFE channels, each having a dedicated ADC in accordance with an embodiment of the invention.

FIG. 4K illustrates a pair of focal planes within an imager array where the columns of each focal plane are read out using two separate dedicated AFE processing channels and are digitized using a shared ADC and the AFE processing channels and ADC can be configured to capture high dynamic range digital image data from each focal plane in accordance with an embodiment of the invention.

FIG. 4L illustrates a pair of focal planes within an imager array where the columns of each focal plane are read out using two separate shared AFE processing channels and are digitized using a shared ADC and the AFE processing channels and ADC can be configured to capture high dynamic range digital image data from each focal plane in accordance with an embodiment of the invention.

FIG. 4M illustrates an AFE processing channel including multiple analog amplifiers and control circuitry configured to switch analog image information between the analog amplifiers on a pixel by pixel basis based upon the output value of the analog image information read out from a pixel in accordance with an embodiment of the invention.

FIG. 4N illustrates an AFE processing channel including a programmable gain analog amplifier and control circuitry configured to switch the analog gain of the programmable gain analog amplifier on a pixel by pixel basis based upon the output value of the analog image information read out from a pixel in accordance with an embodiment of the invention.

FIG. 4O is a flow chart illustrating a method of obtaining high dynamic range light field image data in accordance with an embodiment of the invention.

FIG. 4P is a flow chart illustrating a method of obtaining high dynamic range light field image data by varying the amplification gain applied to analog image information on a pixel by pixel based upon the output value of the analog image information read out from a pixel in accordance with an embodiment of the invention.

FIG. 4Q is a flow chart illustrating a method of configuring an imager array to capture image data in either a standard image capture mode or a high dynamic range image capture mode in accordance with an embodiment of the invention.

FIG. 5 illustrates a backside illuminated imager array with optimized thinning depths in accordance with an embodiment of the invention.

### DETAILED DISCLOSURE OF THE INVENTION

Turning now to the drawings, array cameras and imager arrays configured to capture high dynamic range light field image data and methods of capturing high dynamic range light field image data in accordance with embodiments of the invention are illustrated. Imager arrays in accordance with many embodiments of the invention include multiple focal planes. The term focal plane describes a two dimensional arrangement of pixels. Focal planes in an imager array are typically non-overlapping (i.e. each focal plane is located within a separate region on the imager array). Each focal plane in the imager array can include a plurality of rows of pixels that also form a plurality of columns of pixels and each focal plane is contained within a region of the imager array that does not contain pixels from another focal plane. The term imager is used to describe the combination of a focal plane and the control circuitry that controls the capture of image information using the pixels within the focal plane. In several embodiments, the control circuitry includes read out circuitry and sampling circuitry. The read out circuitry coordinates the read out of analog image information from individual pixels in a focal plane. The sampling circuitry controls the conversion of the analog image information into digital image data. In certain embodiments, the sampling circuitry includes an Analog Front End (AFE) and an Analog to Digital Converter (ADC). The AFE is circuitry that includes circuitry that amplifies the analog image information read out from a pixel prior to the digitization of the amplified analog image information by the ADC. In a number of embodiments, the focal planes of the imager array can be separately triggered. In several embodiments, the focal planes of the imager array utilize different integration times tailored to the capture band of the pixels within each focal plane. The capture band of a pixel typically refers to a contiguous sub-band of the electromagnetic spectrum to which a pixel is sensitive. In addition, the specialization of specific focal planes so that all or a majority of the pixels in the focal plane have the same capture band enables a number of pixel performance improvements and increases in the efficiency of utilization of peripheral circuitry within the imager array.

In many embodiments, the dynamic range of the image data captured by an imager array can be increased by applying different analog gains to the analog image information read from different pixels within a focal plane prior to analog to digital conversion. In several embodiments, multiple AFE processing channels are provided that each applies a different amplification gain to the analog image information provided to the AFE processing channel. In a number of embodiments, one or more AFE processing channels are provided in which the amplification gain adjusts on a pixel by pixel basis in a predetermined manner or in a manner determined by the output value of the analog image information provided to the AFE processing channel. In several embodiments, multiple AFE processing channels are provided that apply different amplification gains in parallel to the same analog image information read out from each pixel. Application of different amplification gains to the analog image information read out from different pixels within a focal plane can provide increased dynamic range by enabling the use of the analog image information from the pixels to which the high amplification gain is applied in low light regions of a scene and the analog image information from pixels to which the lower gain is applied in brighter regions of the scene. While amplification in low light regions can be performed after the pixel samples have been converted to digital data, the result is not equivalent. Amplification in the digital domain amplifies both the image information and the noise in the image, which includes the quantization noise introduced by the step size of the ADC during digitization. Typically, the noise introduced by the AFE does not increase with the gain applied to the analog pixel output. Therefore, amplifying the signal in the analog domain prior to quantization can result in a higher signal to noise ratio due to the lower contribution of quantization noise in the resulting amplified signal. Also, since the AFE contains numerous injection points for noise (e.g. some noise sources are after the amplification or each amplification stage), the input referred noise of the amplifier can decrease as gain increases thus providing a higher signal to noise ratio.

In several embodiments, the AFEs can utilize programmable gain analog amplifiers. In several embodiments, a programmable gain analog amplifier is utilized in which the amplification gain of the programmable gain analog amplifier is selected on a pixel by pixel basis based upon the output value of the analog image information read out from a pixel.

In a number of embodiments, the use of programmable gain analog amplifiers enables the imager array to be configurable to operate in a standard image capture mode in which a uniform amplification gain is applied to the pixels read out from a given focal plane or a high dynamic range image capture mode in which different amplification gains are applied to the analog image information read out from the pixels in a given focal plane. Where the focal planes form part of an array camera configured to synthesize a high resolution image based on captured image data using super-resolution processing, greater increases in resolution can be achieved in standard image capture mode and increased dynamic range can be obtained in high dynamic range image capture mode. In a number of embodiments, the imager array configures specific focal planes to operate in a standard image capture mode for the purpose of obtaining increased resolution during super-resolution processing of the captured image data and specific focal planes to operate in high dynamic range image capture mode to decrease the likelihood of occlusions in the captured high dynamic range image data. In embodiments where different amplification gains are applied on a pixel by pixel basis and/or where the analog image information read out form a pixel is provided to parallel AFE processing channels that apply different amplification gains the trade off between resolution and increased dynamic range may not be significant. In certain embodiments, additional data can be included in high dynamic range light field image data including (but not limited to) additional data indicating that the imager array is operating in a high dynamic range image capture mode, additional data indicating the image capture mode in which a specific focal plane(s) is operating, and/or additional data indicating the amplification gain applied to the analog image information read out from a pixel and digitized to create a specific piece of digital image data. Array cameras and imager arrays configured to capture high dynamic range light field image data in accordance with embodiments of the invention are discussed further below.

### 1. Array Camera Architecture

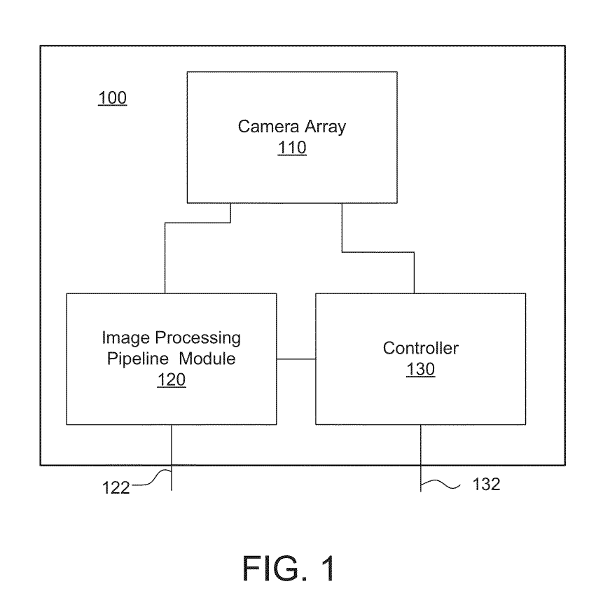

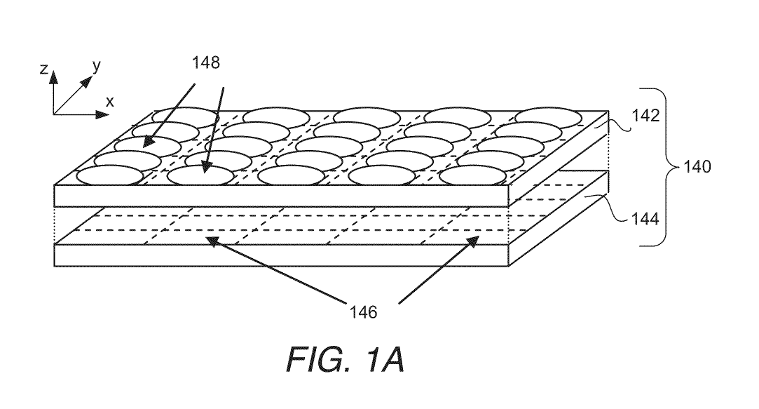

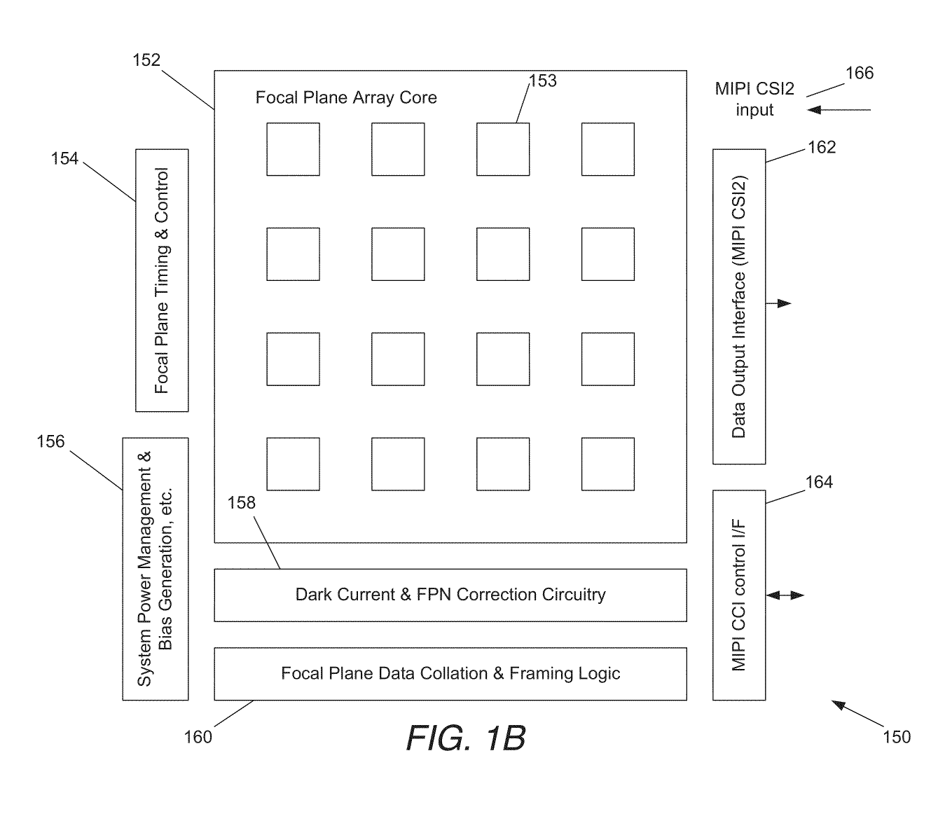

An array camera architecture that can be used in a variety of array camera configurations including array cameras configured to capture high dynamic range light field image data in accordance with embodiments of the invention is illustrated in FIG. 1. The array camera 100 includes an imager array 110, which is connected to an image processing pipeline module 120 and to a controller 130.

The imager array 110 includes an M×N array of individual and independent focal planes, each of which receives light through a separate lens system. The imager array can also include other circuitry to control the capture of image data using the focal planes and one or more sensors to sense physical parameters. The control circuitry can control imaging and functional parameters such as exposure times, trigger times, amplification gain, and black level offset. The control circuitry can also control the capture of image information by controlling read-out direction (e.g. top-to-bottom or bottom-to-top, and left-to-right or right-to-left). The control circuitry can also control read-out of a region of interest, horizontal sub-sampling, vertical sub-sampling, and/or charge-binning. In many embodiments, the circuitry for controlling imaging parameters may trigger each focal plane separately or in a synchronized manner. The imager array can include a variety of other sensors, including but not limited to, dark pixels to estimate dark current at the operating temperature. Imager arrays that can be utilized in array cameras in accordance with embodiments of the invention are disclosed in PCT Publication WO 2009/151903 to Venkataraman et al., the disclosure of which is incorporated herein by reference in its entirety. In a monolithic implementation, the imager array may be implemented using a monolithic integrated circuit. When an imager array in accordance with embodiments of the invention is implemented in a single self-contained SOC chip or die, the imager array can be referred to as an imager array. The term imager array can be used to describe a semiconductor chip on which the imager array and associated control, support, and read-out electronics are integrated. In several embodiments, the control circuitry can configure the imager array to capture light field image data in a standard image capture mode and high dynamic range light field image data in a high dynamic range image capture mode.

The image processing pipeline module 120 is hardware, firmware, software, or a combination thereof for processing the images received from the imager array 110. The image processing pipeline module 120 typically processes the (low resolution) light field image data captured by the camera array and produces a synthesized higher resolution image in accordance with an embodiment of the invention. In a number of embodiments, the image processing pipeline module 120 provides the synthesized image data via an output 122. Various image processing pipeline modules that can be utilized in a camera array in accordance with embodiments of the invention are disclosed in U.S. patent application Ser. No. 12/967,807 entitled “System and Methods for Synthesizing High Resolution Images Using Super-Resolution Processes” filed Dec. 14, 2010, the disclosure of which is incorporated by reference herein in its entirety. In several embodiments, the image processing pipeline module 120 is configured to use high dynamic range light field image data to synthesize a higher resolution image using super-resolution processes and the higher dynamic range color information contained in the high dynamic range light field image data.

The controller 130 is hardware, software, firmware, or a combination thereof for controlling various operation parameters of the imager array 110. As can be readily appreciated, both the image processing pipeline and the controller can be at least partially implemented via software executing on the same processor. In many embodiments, the controller 130 receives inputs 132 from a user or other external components and sends operation signals to control the imager array 110. In a number of embodiments, the controller provides the imager array with configuration commands that can configure the imager array to capture image data in a standard image capture mode and a high dynamic range image capture mode. The controller 130 can also send information to the image processing pipeline module 120 to assist processing of the digital image data output by the imager array 110.

Although a specific array camera architecture is illustrated in FIG. 1, alternative architectures for capturing high dynamic range light field image data can also be utilized in accordance with embodiments of the invention. Operation of array cameras, imager array configurations, and processing image data captured by multiple focal planes in accordance with embodiments of the invention are discussed further below.

### 2. Array Camera Modules

Array camera modules in accordance with many embodiments of the invention include the combination of an optic array of lens stacks and an imager array that includes an array of focal planes. Each lens stack in the optic array defines a separate optical channel. The optic array may be mounted to an imager array that includes a focal plane for each of the optical channels, where each focal plane includes an array of pixels or sensor elements configured to capture an image. When the optic array and the imager array are combined with sufficient precision, the array camera module can be utilized to capture image data that can be used to construct multiple images of a scene that can be read out to a processor for further processing, e.g. to synthesize a high resolution image using super-resolution processing.

An exploded view of an array camera module formed by combining a lens stack array with a monolithic sensor including an array of focal planes in accordance with an embodiment of the invention is illustrated in FIG. 1A. The array camera module 140 includes an optic array 142 and an imager array 144 that includes an array of focal planes 146. The lens stack array 142 includes an array of lens stacks 148. Each lens stack 148 creates an optical channel that resolves an image on one of the focal planes 146 on the imager array 144. Each of the lens stacks 148 may be of a different type. In several embodiments, the optical channels are used to capture images of different portions of the light spectrum and the lens stack in each optical channel is specifically optimized for the portion of the spectrum imaged by the focal plane associated with the optical channel.

In many embodiments, the array camera module 140 includes lens stacks 148 having one or multiple separate optical lens elements axially arranged with respect to each other. Optic arrays of lens stacks 142 in accordance with several embodiments of the invention include one or more adaptive optical elements that can enable the independent adjustment of the focal length of each lens stack and/or later shifting of the centration of the refractive power distribution of the adaptive optical element. The use of adaptive optical elements is described in U.S. patent application Ser. No. 13/650,039, entitled “Lens Stack Arrays Including Adaptive Optical Elements”, filed Oct. 11, 2012, the disclosure of which is incorporated by reference herein in its entirety.

In several embodiments, the array camera module employs wafer level optics (WLO) technology. WLO is a technology that encompasses a number of processes, including, for example, molding of lens arrays on glass wafers, stacking of those wafers (including wafers having lenses replicated on either side of the substrate) with appropriate spacers, followed by packaging of the optics directly with the imager into a monolithic integrated module. The WLO procedure may involve, among other procedures, using a diamond-turned mold to create each plastic lens element on a glass substrate. More specifically, the process chain in WLO generally includes producing a diamond turned lens master (both on an individual and array level), then producing a negative mold for replication of that master (also called a stamp or tool), and then finally forming a polymer replica on a glass substrate, which has been structured with appropriate supporting optical elements, such as, for example, apertures (transparent openings in light blocking material layers), and filters. Although the construction of lens stack arrays using WLO is discussed above, any of a variety of techniques can be used to construct lens stack arrays, for instance those involving precision glass molding, polymer injection molding or wafer level polymer monolithic lens processes.

Although certain array camera module configurations have been discussed above, any of a variety of array camera modules that utilize lens stacks and focal planes may be implemented in accordance with embodiments of the invention. Imager array architectures and imager arrays configured to capture extended dynamic range image information in accordance with embodiments of the invention are discussed further below.

### 3. Imager Array Architectures

Imager arrays in accordance with embodiments of the invention include a plurality of focal planes where each focal plane includes a plurality of rows of pixels that also form a plurality of columns of pixels and each focal plane is contained within a region of the imager array that does not contain pixels from another focal plane. These focal planes can be used in combination with the separate lens stacks in an optic array of lens stacks to form a plurality of cameras that can each capture image data of a scene through a separate aperture. An imager array in accordance with an embodiment of the invention is illustrated in FIG. 1B. The imager array includes a focal plane array core 152 that includes an array of focal planes 153 and all analog signal processing, pixel level control logic, signaling, and analog-to-digital conversion circuitry. The imager array also includes focal plane timing and control circuitry 154 that is responsible for controlling the capture of image information using the pixels. In a number of embodiments, the focal plane timing and control circuitry utilizes reset and read-out signals to control the integration time of the pixels. In other embodiments, any of a variety of techniques can be utilized to control integration time of pixels and/or to capture image information using pixels. In many embodiments, the focal plane timing and control circuitry 154 provides flexibility of image information capture control, which enables features including (but not limited to) high dynamic range imaging, high speed video, and electronic image stabilization. In various embodiments, the imager array includes power management and bias generation circuitry 156. The power management and bias generation circuitry 156 provides current and voltage references to analog circuitry such as the reference voltages against which an ADC would measure the signal to be converted against. In many embodiments, the power management and bias circuitry also includes logic that turns off the current/voltage references to certain circuits when they are not in use for power saving reasons. In several embodiments, the imager array includes dark current and fixed pattern (FPN) correction circuitry 158 that increases the consistency of the black level of the image data captured by the imager array and can reduce the appearance of row temporal noise and column fixed pattern noise. In several embodiments, each focal plane includes reference pixels for the purpose of calibrating the dark current and FPN of the focal plane and the control circuitry can keep the reference pixels active when the rest of the pixels of the focal plane are powered down in order to increase the speed with which the imager array can be powered up by reducing the need for calibration of dark current and FPN. In many embodiments, the SOC imager includes focal plane framing circuitry 160 that packages the data captured from the focal planes into a container and can prepare the captured image data for transmission. In several embodiments, the focal plane framing circuitry adds information identifying the focal plane and/or group of pixels from which the captured image data originated. In many embodiments, the focal plane framing circuitry adds additional data indicating the image capture mode utilized by the imager array, the image capture mode utilized by individual focal planes, and/or the amplification gain applied to individual pieces of digital image data. In a number of embodiments, the imager array also includes an interface for transmission of captured image data to external devices. In the illustrated embodiment, the interface is a MIPI CSI 2 output interface supporting four lanes that can support read-out of video at 30 fps from the imager array and incorporating data output interface circuitry 162, interface control circuitry 164 and interface input circuitry 166. Typically, the bandwidth of each lane is optimized for the total number of pixels in the imager array and the desired frame rate. The use of various interfaces including the MIPI CSI 2 interface to transmit image data captured by an array of imagers within an imager array to an external device in accordance with embodiments of the invention is described in U.S. Pat. No. 8,305,456 to McMahon, the disclosure of which is incorporated by reference herein in its entirety. Although specific components of an imager array architecture are discussed above with respect to FIG. 1B. As is discussed further below, any of a variety of imager arrays can be constructed in accordance with embodiments of the invention that enable the capture of images of a scene at a plurality of focal planes in accordance with embodiments of the invention. Accordingly, focal plane array cores and various components that can be included in imager arrays in accordance with embodiments of the invention are discussed further below.

### 4. Focal Plane Array Cores

Focal plan array cores in accordance with embodiments of the invention include an array of imagers and dedicated peripheral circuitry for capturing image data using the pixels in each focal plane. Imager arrays in accordance with embodiments of the invention can include focal plan array cores that are configured in any of a variety of different configurations appropriate to a specific application. For example, customizations can be made to specific imager array designs including (but not limited to) with respect to the focal plane, the pixels, and the dedicated peripheral circuitry. Various focal plane, pixel designs, and peripheral circuitry that can be incorporated into focal plane array cores in accordance with embodiments of the invention are discussed below.

### 4.1. Formation of Focal Planes on an Imager Array

An imager array can be constructed in which the focal planes are formed from an array of pixel elements, where each focal plane is a sub-array of pixels. In embodiments where each sub-array has the same number of pixels, the imager array includes a total of K×L pixel elements, which are segmented in M×N sub-arrays of X×Y pixels, such that K=M×X, and L=N×Y. In the context of an imager array, each sub-array or focal plane can be used to generate a separate image of the scene. Each sub-array of pixels provides the same function as the pixels of a conventional imager (i.e. the imager in a camera that includes a single focal plane).

As is discussed further below, an imager array in accordance with embodiments of the invention can include a single controller that can separately sequence and control each focal plane. Having a common controller and I/O circuitry can provide important system advantages including lowering the cost of the system due to the use of less silicon area, decreasing power consumption due to resource sharing and reduced system interconnects, simpler system integration due to the host system only communicating with a single controller rather than M×N controllers and read-out I/O paths, simpler array synchronization due to the use of a common controller, and improved system reliability due to the reduction in the number of interconnects.

### 4.2. Layout of Imagers

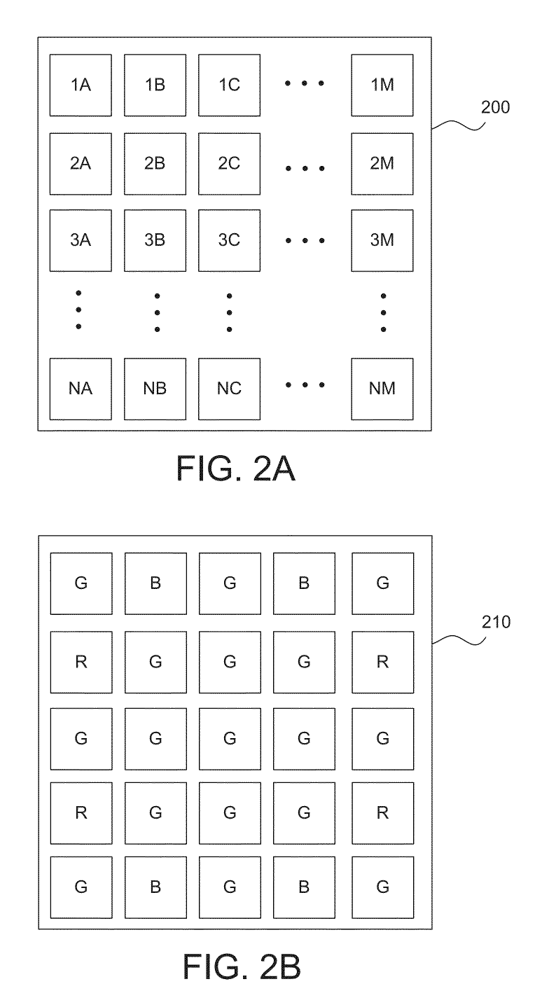

As is disclosed in P.C.T. Publication WO 2009/151903 (incorporated by reference above), an imager array can include any M×N array of focal planes such as the imager array (200) illustrated in FIG. 2A. Each of the focal planes typically has an associated filter and/or optical elements and can image different wavelengths of light. In a number of embodiments, the imager array includes focal planes that sense red light (R), focal planes that sense green light (G), and focal planes that sense blue light (B). Although in several embodiments, one or more of the focal planes include pixels that are configured to capture different colors of light. In a number of embodiments, the pixels employ a Bayer filter pattern (or similar) pattern that enables different pixels within a focal plane to capture different colors of light. In several embodiments, a 2×2 imager array can include a focal plane where the pixels employ a Bayer filter pattern (or similar), a focal plane where the pixels are configured to capture blue light, a focal plane where the image is configured to capture green light, and a focal plane where the imager is configured to capture red light. Array cameras incorporating such sensor arrays can utilize the color information captured by the blue, green, and red focal planes to enhance the colors of the image captured using the focal plane that employs the Bayer filter. In other embodiments, the focal plane that employs the Bayer pattern is incorporated into an imager array that includes a two dimensional arrangement of focal planes where there are at least three focal planes in one of the dimensions. In a number of embodiments, there are at least three focal planes in both dimensions.

The human eye is more sensitive to green light than to red and blue light, therefore, an increase in the resolution of an image synthesized from the low resolution image data captured by an imager array can be achieved using an array that includes more focal planes that sense green light than focal planes that sense red or blue light. A 5×5 imager array (210) including 17 focal planes that sense green light (G), four focal planes that sense red light (R), and four focal planes that sense blue light (B) is illustrated in FIG. 2B. In several embodiments, the imager array also includes focal planes that sense near-IR wavelengths or extended-color wavelengths (i.e. spanning both color and near-IR wavelengths), which can be used to improve the performance of the array camera in low light conditions. In other embodiments, the 5×5 imager array includes at least 13 focal planes that sense green light (G), at least 15 focal planes that sense green light (G), or at least 17 focal planes that sense green light (G). In addition, the 5×5 imager array can include at least four focal planes that sense red light, and/or at least four focal planes that sense blue light. In addition, the number of focal planes that sense red light and the number of focal planes that sense blue light can be the same, but need not be the same. Indeed, several imager arrays in accordance with embodiments of the invention include different numbers of focal planes that sense red light and that sense blue light. In many embodiments, other arrays are utilized including (but not limited to) 3×2 arrays, 3×3 arrays, 3×4 arrays, 4×4 arrays, 4×5 arrays, 4×6 arrays, 5×5 arrays, 5×6 arrays, 6×6 arrays, 3×7 arrays, and 1×N arrays. In a number of embodiments, the imager array includes a two dimensional array of focal planes having at least three focal planes in one of the dimensions. In several embodiments, there are at least three focal plane in both dimensions of the array. In several embodiments, the array includes at least two focal planes having pixels configured to capture blue light, at least two focal planes having pixels configured to capture green light, and at least two focal planes having pixels configured to capture red light.

Additional imager array configurations are disclosed in U.S. patent application Ser. No. 12/952,106 entitled “Capturing and Processing of Images Using Monolithic Camera Array with Heterogenous Imagers” to Venkataraman et al., the disclosure of which is incorporated by reference herein in its entirety.

Although specific imager array configurations are disclosed above, any of a variety of regular or irregular layouts of imagers including imagers that sense visible light, portions of the visible light spectrum, near-IR light, other portions of the spectrum and/or combinations of different portions of the spectrum can be utilized to capture images that provide one or more channels of information for use in SR processes in accordance with embodiments of the invention. The construction of the pixels of an imager in an imager array in accordance with an embodiment of the invention can depend upon the specific portions of the spectrum imaged by the imager. Different types of pixels that can be used in the focal planes of an imager array in accordance with embodiments of the invention are discussed below.

### 4.3. Pixel Design

Within an imager array that is designed for color or multi-spectral capture, each individual focal plane can be designated to capture a sub-band of the visible spectrum. Each focal plane can be optimized in various ways in accordance with embodiments of the invention based on the spectral band it is designated to capture. These optimizations are difficult to perform in a legacy Bayer pattern based image sensor since the pixels capturing their respective sub-band of the visible spectrum are all interleaved within the same pixel array. In many embodiments of the invention, backside illumination is used where the imager array is thinned to different depths depending upon the capture band of a specific focal plane. In a number of embodiments, the sizes of the pixels in the imager array are determined based upon the capture band of the specific imager. In several embodiments, the conversion gains, source follower gains, and full well capacities of groups of pixels within a focal plane are determined based upon the capture band of the pixels. The various ways in which pixels can vary between focal planes in an imager array depending upon the capture band of the pixel are discussed further below.

4.3.1. Backside Illuminated Imager Array with Optimized Thinning Depths

A traditional image sensor is illuminated from the front side where photons must first travel through a dielectric stack before finally arriving at the photodiode, which lies at the bottom of the dielectric stack in the silicon substrate. The dielectric stack exists to support metal interconnects within the device. Front side illumination suffers from intrinsically poor Quantum Efficiency (QE) performance (the ratio of generated carriers to incident photons), due to problems such as the light being blocked by metal structures within the pixel. Improvement is typically achieved through the deposition of micro-lens elements on top of the dielectric stack for each pixel so as to focus the incoming light in a cone that attempts to avoid the metal structures within the pixel.

Backside illumination is a technique employed in image sensor fabrication so as to improve the QE performance of imagers. In backside illumination (BSI), the silicon substrate bulk is thinned (usually with a chemical etch process) to allow photons to reach the depletion region of the photodiode through the backside of the silicon substrate. When light is incident on the backside of the substrate, the problem of aperturing by metal structures inherent in frontside illumination is avoided. However, the absorption depth of light in silicon is proportional to the wavelength such that the red photons penetrate much deeper than blue photons. If the thinning process does not remove sufficient silicon, the depletion region will be too deep to collect photo electrons generated from blue photons. If the thinning process removes too much silicon, the depletion region can be too shallow and red photons may travel straight though without interacting and generating carriers. Red photons could also be reflected from the front surface back and interact with incoming photons to create constructive and destructive interference due to minor differences in the thickness of the device. The effects caused by variations in the thickness of the device can be evident as fringing patterns and/or as spiky spectral QE response.

In a conventional imager, a mosaic of color filters (typically a Bayer filter) is often used to provide RGB color capture. When a mosaic based color imager is thinned for BSI, the thinning depth is typically the same for all pixels since the processes used do not thin individual pixels to different depths. The common thinning depth of the pixels results in a necessary balancing of QE performance between blue wavelengths and red/near-IR wavelengths. An imager array in accordance with embodiments of the invention includes an array of imagers, where each pixel in a focal plane senses the same spectral wavelengths. Different focal planes can sense different sub-bands of the visible spectrum or indeed any sub-band of the electromagnetic spectrum for which the band-gap energy of silicon has a quantum yield gain greater than 0. Therefore, performance of an imager array can be improved by using BSI where the thinning depth for the pixels of a focal plane is chosen to match optimally the absorption depth corresponding to the wavelengths of light each pixel is designed to capture. In a number of embodiments, the silicon bulk material of the imager array is thinned to different thicknesses to match the absorption depth of each camera's capture band within the depletion region of the photodiode so as to maximize the QE.

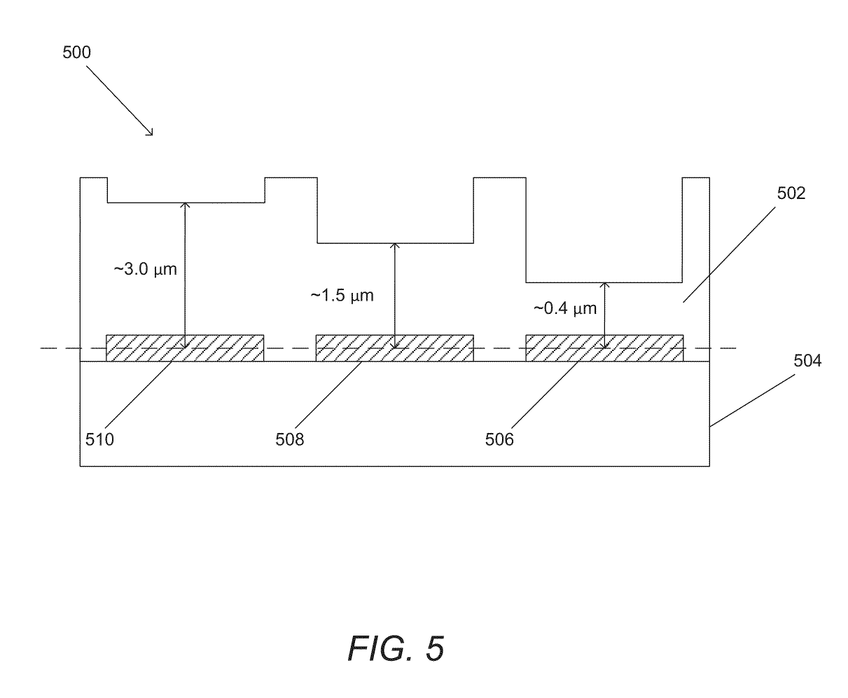

An imager array in which the silicon substrate is thinned to different depths in regions corresponding to focal planes (i.e. sub-arrays) that sense different spectral bandwidths in accordance with an embodiment of the invention is conceptually illustrated in FIG. 5. The imager array 500 includes a silicon substrate 502 on the front side of which a dielectric stack and metal interconnects 504 are formed. In the illustrated embodiment, the silicon substrate includes regions 506, 508, 510 in which the photodiodes of pixels forming a focal plane for sensing blue light, the photodiodes of pixels forming a focal plane for sensing green light, and the photodiodes of pixels forming a focal plane for sensing red light respectively are located. The backside of the silicon substrate is thinned to different depths in each region. In the illustrated embodiment, the substrate is thinned to correspond to the absorption depth of 450 nm wavelength light (i.e. approximately 0.4 μm) in the region 506 in which the photodiodes of pixels forming an imager for sensing blue light are located, the substrate is thinned to correspond to the absorption depth of 550 nm wavelength light (i.e. approximately 1.5 μm) in the region 508 in which the photodiodes of pixels forming an imager for sensing green light are located, and the substrate is thinned to correspond to the absorption depth of 640 nm wavelength light (i.e. approximately 3.0 μm) in the region 510 in which the photodiodes of pixels forming an imager for sensing red light are located. Although specific depths are shown in FIG. 5, other depths appropriate to the spectral wavelengths sensed by a specific imager and the requirements of the application can be utilized in accordance with embodiments of the invention. In addition, different thinning depths can also be used in array cameras that are not implemented using imager arrays in accordance with embodiments of the invention.

In many embodiments, the designation of color channels to each imager within the array is achieved via a first filtration of the incoming photons through a band-pass filter within the optical path of the photons to the photodiodes. In several embodiments, the thinning depth itself is used to create the designation of capture wavelengths since the depletion region depth defines the spectral QE of each imager.

### 4.3.2. Optimization of Pixel Size

Additional SNR benefits can be achieved by changing the pixel sizes used in the imagers designated to capture each sub-band of the spectrum. As pixel sizes shrink, the effective QE of the pixel decreases since the ratio of photodiode depletion region area to pixel area decreases. Microlenses are typically used to attempt to compensate for this and they become more important as the pixel size shrinks. Another detriment to pixel performance by pixel size reduction comes from increased noise. To attempt to maintain the balance of photo-active to read-out circuit area, in many embodiments, the pixel transfer gate, source follower amplifier transistor and reset transistors are also made smaller. As these transistors reduce in size, numerous performance parameters are degraded typically resulting in noise increase.

Electrical “cross-talk” also increases as a function of reduced pixel-to-pixel spacing. Long wavelength photons penetrate deeper into the substrate before interacting with the silicon to create a charge carrier. These charge carriers wander in a somewhat random fashion before resurfacing and collection in a photodiode depletion region. This “circle” of probable resurface and collection increases as a function of generation depth. Thus the smaller the pixels become, the greater the number of pixels the circle of probable resurface covers. This effect results in a degradation of the Modulation Transfer Function (MTF) with increase in photon wavelength.

Imagers designated to capture longer wavelengths can therefore be optimized to improve system SNR by increasing the pixel size and thus increasing the QE of the pixel. Since MTF drops as a function of increased wavelength, the benefit of smaller pixels for resolution purposes is diminished with increased wavelength. Overall system resolution can thus be maintained while increasing the pixel size for longer wavelengths so as to improve QE and thus improve the overall system SNR. Although in many embodiments, imager arrays in accordance with embodiments of the invention utilize as small pixels as can be manufactured. Accordingly, increasing pixel size in the manner outlined above is simply one technique that can be utilized to improve camera performance and the specific pixel size chosen typically depends upon the specific application.

### 4.3.3. Imager Optimization

The push for smaller and smaller pixels has encouraged pixel designers to re-architect the pixels such that they share read-out circuits within a neighborhood. For example, a group of four photodiodes may share the same reset transistor, floating diffusion node and source follower amplifier transistors. When the four pixels are arranged in a Bayer pattern arrangement, the group of four pixels covers the full visible spectrum of capture. In imager arrays in accordance with embodiments of the invention, these shared pixel structures can be adapted to tailor the performance of pixels in a focal plane to a given capture band. The fact that these structures are shared by pixels that have different capture bands in a traditional color filter array based image sensor means that the same techniques for achieving performance improvements are typically not feasible. The improvement of the performance of pixels in a focal plane by selection of conversion gain, source follower gain, and full well capacity based upon the capture band of the pixels is discussed below. Although the discussion that follows is with reference to 4T CMOS pixels, similar improvements to pixel performance can be achieved in any imager array in which pixels share circuitry in accordance with embodiments of the invention.

### 4.3.3.1. Optimization of Conversion Gain

The performance of imagers within an imager array that are intended to capture specific sub-bands of the spectrum can be improved by utilizing pixels with different conversion gains tailored for each of the different capture bands. Conversion gain in a typical 4T CMOS pixel can be controlled by changing the size of the capacitance of the “sense node”, typically a floating diffusion capacitor (FD). The charge to voltage conversion follows the equation V=Q/C where Q is the charge, C is the capacitance and V is the voltage. Thus the smaller the capacitance, the higher the voltage resulting from a given charge hence the higher the charge-to-voltage conversion gain of the pixel. The conversion gain cannot obviously be increased infinitely however. The apparent full well capacity of the pixel (number of photo-electrons the pixel can record) will decrease if the capacitance of the FD becomes too small. This is because the electrons from the photodiode transfer into the FD due to a potential difference acting on them. Charge transfer will stop when the potential difference is zero (or a potential barrier exists between the PF and the FD). Thus if the capacitance of the FD is too small, the potential equilibrium may be reached before all electrons have been transferred out of the photodiode.

### 4.3.3.2. Optimization of Source Follower Gain

Additional performance gains can be achieved by changing the characteristics of the amplifiers in each pixel within a focal plane. The amplifier in a traditional 4T CMOS pixel is constructed from a Source Follower transistor. The Source Follower transistor amplifies the voltage across the FD so as to drive the pixel signal down the column line to the column circuit where the signal is subsequently sampled.

The output voltage swing as a function of the input voltage swing (i.e. the Source Follower amplifier's gain) can be controlled during fabrication by changing the implant doping levels. Given the pixel photodiode's full well capacity (in electrons) and the capacitance of the FD, a range of voltages are established at the input of the Source Follower transistor by the relationship Vin=Vrst−Q/C where Vrst is the reset voltage of the FD, Q is the charge of the electrons transferred to the FD from the photodiode and C is the capacitance of the FD.

The photodiode is a pinned structure such that the range of charge that may be accumulated is between 0 electrons and the full well capacity. Therefore, with a given full well capacity of the photodiode and a given capacitance of the FD and a desired output signal swing of the source follower, the optimal gain or a near optimal gain for the source follower transistor can be selected.

### 4.3.3.3. Optimization of Full Well Capacity

Another optimization that can be performed is through changing the full well capacity of the photodiodes. The full well capacity of the photodiode is the maximum number of electrons the photodiode can store in its maximally depleted state. The full well of the pixels can be controlled through the x-y size of the photodiode, the doping levels of the implants that form the diode structure and the voltage used to reset the pixel.

### 4.3.3.4. Three Parameter Optimization

As can be seen in the previous sections, there are three main characteristics that can be tuned in order to configure pixels within a focal plane that have the same capture band for improved imaging performance. The optimal solution for all three parameters is dependent on the targeted behavior of a particular focal plane. Each focal plane can be tailored to the spectral band it is configured to capture. While the design of the pixel can be optimized, in many embodiments the performance of the pixels is simply improved with respect to a specific capture band (even though the improvement may not be optimal). An example optimization is as follows and similar processes can be used to simply improve the performance of a pixel with respect to a specific capture band:

a. Optimization of the Photodiode Full Well Capacity.

Given the speed of the optics and the transmittance of the color filters, it is possible to estimate the number of electrons that will be generated given a minimum integration time (e.g. 50 μs) for a given maximum spectral radiance. Each sub-band of the spectrum (color) will likely have a different number of electrons generated. The full well capacities of the photodiodes for each sub-band (color) can be chosen such that the maximum radiance within that band under minimum integration times will fill the well. The means by which this target full well capacity is achieved could be through changing the x-y dimensions, changing the doping levels during diode fabrication, changing the reset voltage of the pixels or a combination of two or more of these parameters.

b. Optimization of Conversion Gain

The next step is to optimize the conversion gain of the pixels. Given the number of electrons defined in the full well optimization step, an optimal capacitance for the floating diffusion can be chosen. The optimal capacitance is one, which maintains a potential difference to support charge transfer from the FD such that the full well capacity can be transferred in a reasonable duration of time. The goal of this optimization is to choose the smallest capacitance possible such that the charge to voltage conversion gain is as high as possible such that input referred noise is minimized and hence the maximum SNR for each color channel is realized.

c. Optimization of Source Follower Gain

Once the optimal full-well capacity and charge to voltage conversion gain is determined, the source follower amplifier gain can be chosen. The difference between the reset voltage of the FD (Vrst) and the voltage of the FD containing a full well charge load (Vrst-Q/C) enables the definition of an optimal gain for the source follower amplifier. The source follower gain defines the output signal swing between Vrst and Vrst-Q/C. The optimal signal swing is defined by such parameters as the operating voltage of the analog signal processing and the A/D converter that sample and covert the pixel output signal. The source follower gain is chosen for each color channel such that their respective signal swings are all matched to each other and match the maximum signal swing supported by the analog signal processing and A/D converter circuits.

Having performed these pixel level optimizations on a per capture band basis, the system will have the maximum SNR and dynamic range for each capture band given linear operation. Although the process described above is designed to provide an optimal solution with regard to maximum SNR and dynamic range, other design criteria can be used in the selection of the three parameters described above to provide improved pixel performance with respect to a specific capture band or application specific desired behavior.

### 4.3.4. Dynamic Range Tailoring

Further optimizations of imager arrays can be achieved by using pixels of different conversion gains within the same spectral band. For example, the “green” imagers could be constructed from pixels that have two or more different conversion gains. Therefore, each “green” imager includes pixels that have a homogeneous conversion gain, which is different to the conversion gain of pixels in another of the “green” imagers in the array. Alternatively, each imager could be constructed from a mosaic of pixels having different conversion gains.

As mentioned previously, as the conversion gain increases beyond a certain threshold, the input referred noise continues to decrease but at the expense of effective full well capacity. This effect can be exploited to yield a system having a higher dynamic range. For example, half of all “green” focal planes could be constructed using a conversion gain that optimizes both input referred noise and full well capacity (a “normal green”). The other half of all “green” focal planes could be constructed from pixels that have a higher conversion gain, hence lower input referred noise and lower effective full well capacity (“fast green”). Areas of a scene having a lower light level could be recovered from the “fast green” pixels (that are not saturated) and areas of brighter light level could be recovered from the “normal green” pixels. The result is an overall increase in dynamic range of the system. Although, a specific 50/50 allocation of focal planes between “fast green” and “normal green” is discussed above the number of focal planes dedicated to “fast” imaging and the number of focal planes dedicated to “normal” imaging is entirely dependent upon the requirements of a specific application. In addition, separate focal planes dedicated to “fast” and “normal” imaging can be utilized to increase the dynamic range of other spectral bands and is not simply limited to increasing the dynamic range with which an imager array captures green light.

A similar effect could be achieved by controlling the integration time of the “fast” and “normal” green sub-arrays such that the “fast” pixels integrate for longer. However in a non-stationary scene, this could result in motion artifacts since the “fast” pixels would integrate the scene motion for longer than the “normal” pixels creating an apparent spatial disparity between the two green channels, which may be undesirable.

### 4.3.5. High Dynamic Range Light Field Imaging

In many embodiments, dynamic range can be increased by applying different analog gains to the samples read from different pixels within a focal plane prior to analog-to-digital conversion. As is discussed further below, each focal plane in an imager array includes read out control logic that typically reads out analog image information from the pixels in a row (or column) of the focal plane on a row-by-row (or column-by-column) basis. Sampling circuitry is utilized to convert the analog image information read from a pixel into digital image data. In many embodiments, the sampling circuitry includes an Analog Signal Processor, which includes an Analog Front End (AFE) and an Analog to Digital Converter (ADC). The AFE typically includes an analog amplifier that amplifies the analog image information read out from a pixel prior to conversion to a digital signal by the ADC. In several embodiments, multiple AFE channels can be provided for each focal plane creating separate AFE processing channels for the pixels in a row (or column) of pixels sampled by the sampling circuitry. In this way, the pixels that are read out are divided into different sets and a different gain can be applied to the analog image information read out from each set of pixels when amplified prior to analog-to-digital conversion. Alternatively, analog image information can be read out from a pixel and provided to the different AFE processing channels, which apply different amplification gains to the analog image information. In this way, a processor can read out multiple pieces of digital image data generated from the analog image information read out from a pixel using the different amplification gains and select the digital image data that provides the best color information. In a number of embodiments, one or more AFE processing channels are provided in which the applied gain adjusts on a pixel by pixel basis in a predetermined manner or in a manner determined by the output value of the analog image information read from a pixel.

By applying different gains to analog image information read out from pixels, the overall dynamic range of the system can be increased by utilizing the image information from the pixels to which a high gain is applied in low light regions of a scene and pixels to which the lower gain is applied in brighter regions of the scene. While amplification in low light regions can be performed after the pixel samples have been converted to digital data, the result is not equivalent. Amplification in the digital domain amplifies both the image information and the noise in the image, which includes the quantization noise introduced by the step size of the ADC during digitization. Typically, the noise introduced by the AFE does not increase with the gain applied to the analog pixel output. Therefore, amplifying the signal in the analog domain prior to quantization can result in a higher signal to noise ratio due to the lower contribution of quantization noise in the resulting amplified signal.

In many embodiments, different gains can be applied to the pixel outputs of a focal plane that incorporates pixels having the same conversion gain. In several embodiments, different gains can be applied to the pixel outputs of a focal plane incorporating pixels having different conversion gains. The analog gain applied to the pixel outputs can be modified depending upon whether the array imager is attempting to capture images at the highest possible resolution or with the largest dynamic range. Although in embodiments where different amplification gains are applied on a pixel by pixel basis and/or where the analog image information read out form a pixel is provided to parallel AFE processing channels that apply different amplification gains, the trade off between resolution and increased dynamic range may not be significant. In a standard image capture mode, the same analog gain is applied to the analog image information read out of all of the pixels sampled by the AFE processing channel(s) in the AFE. In a high dynamic range image capture mode, different analog gains can be applied to the pixel samples in a predetermined manner or on a pixel by pixel basis.

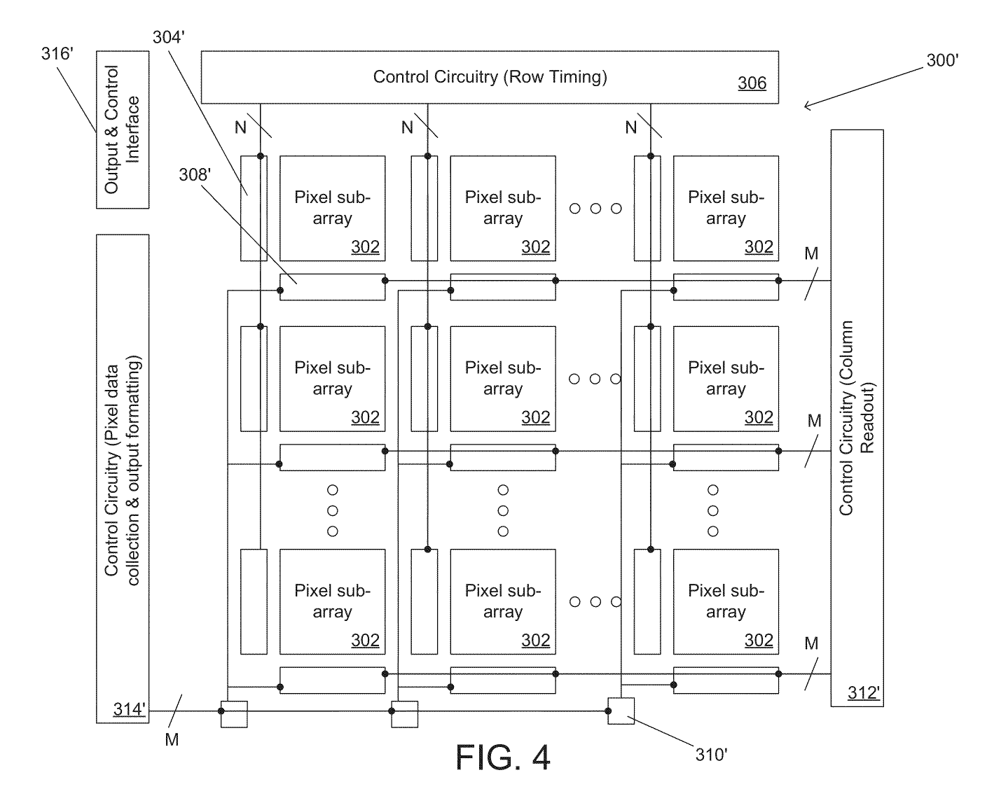

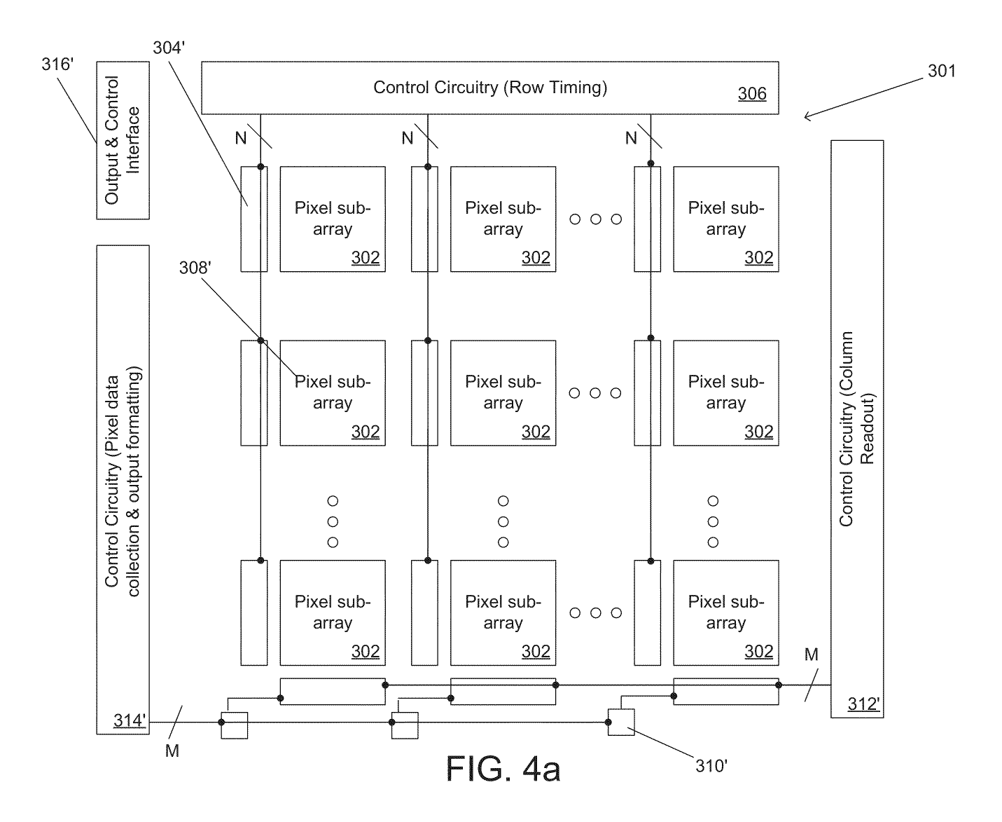

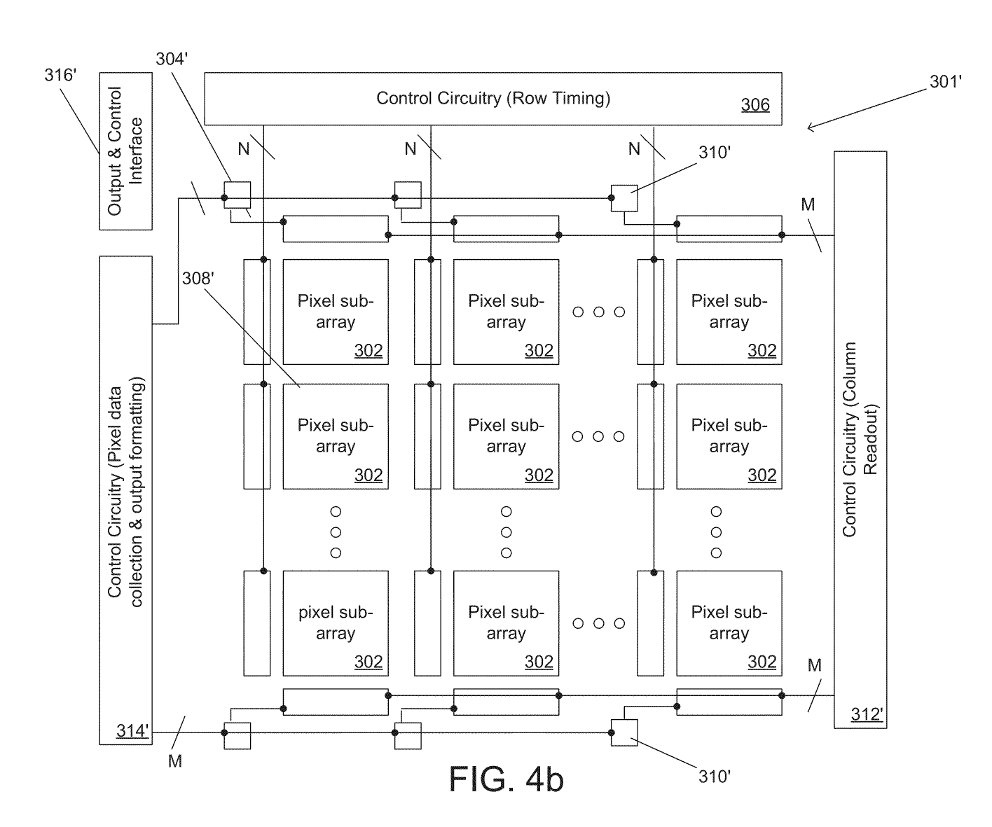

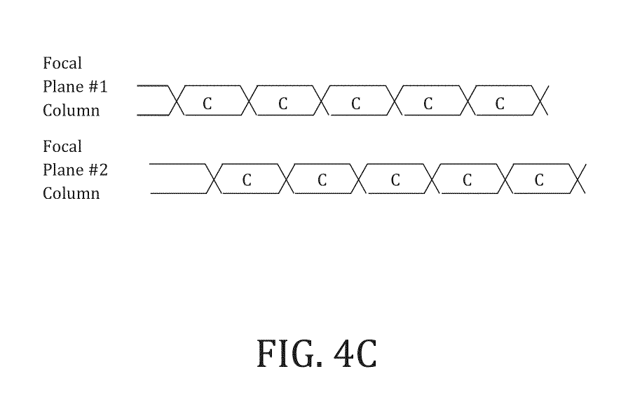

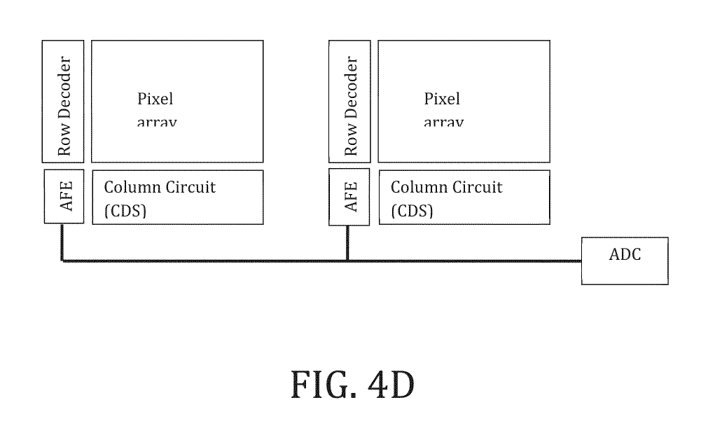

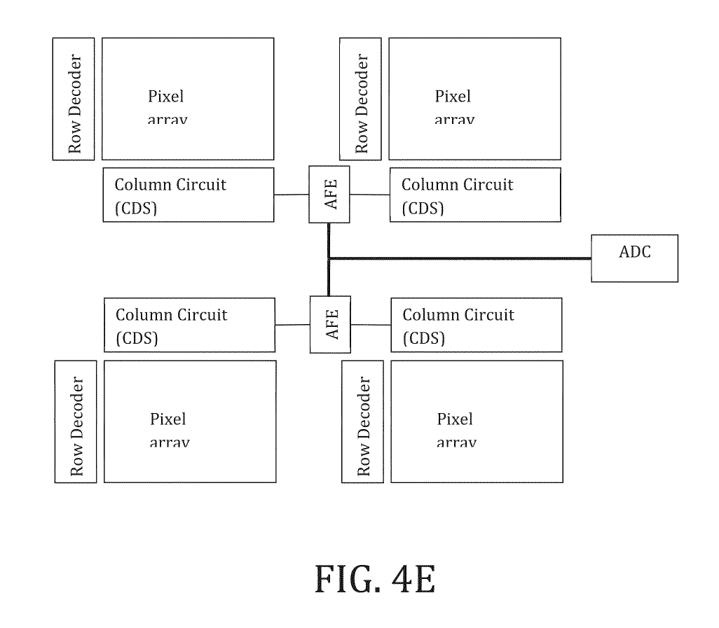

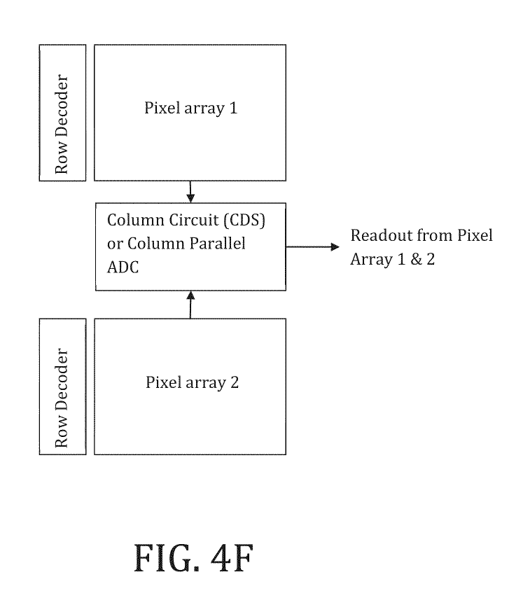

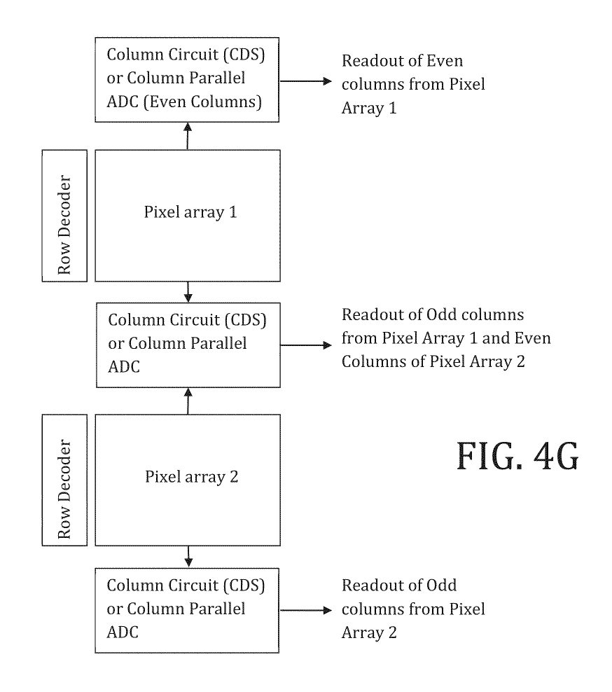

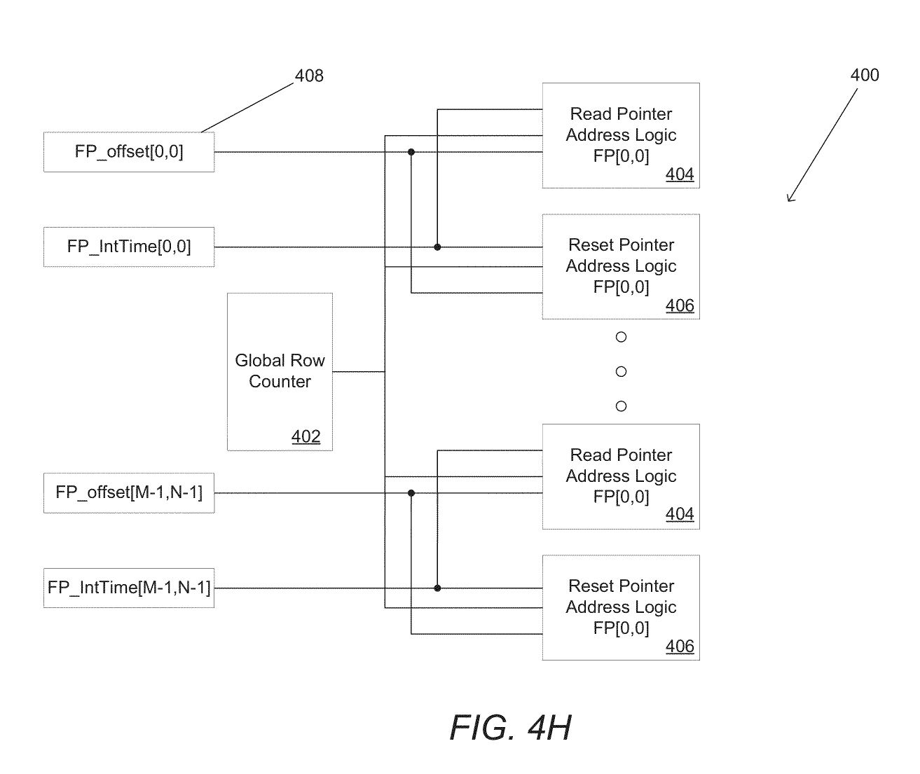

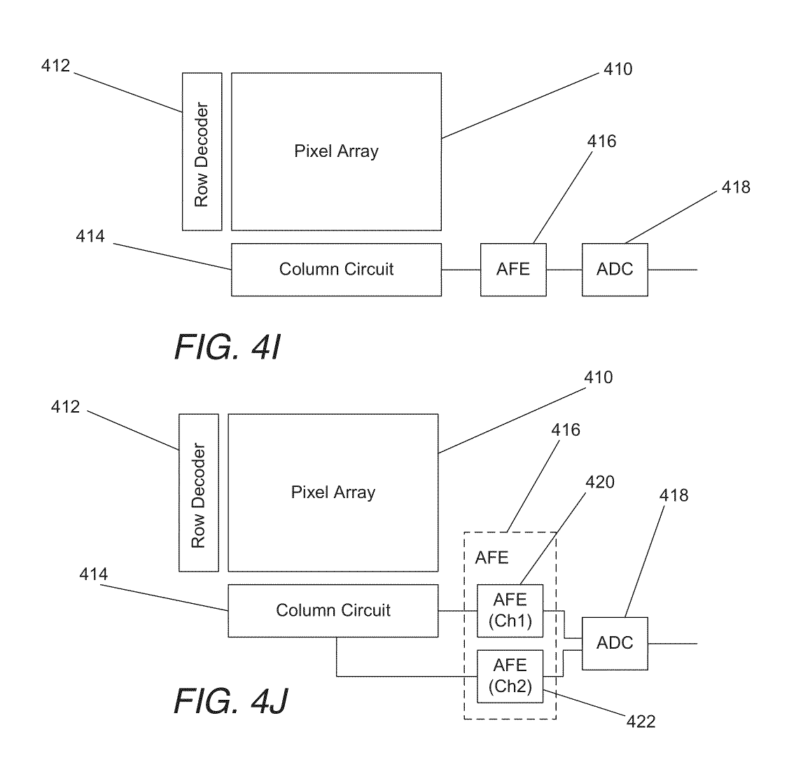

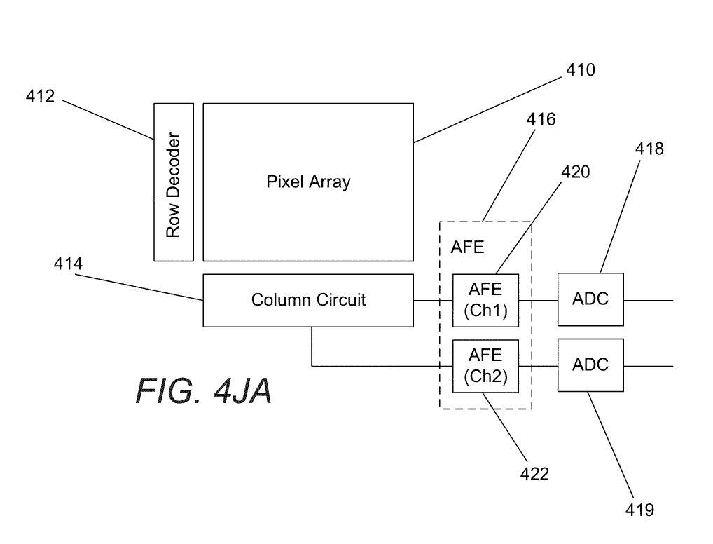

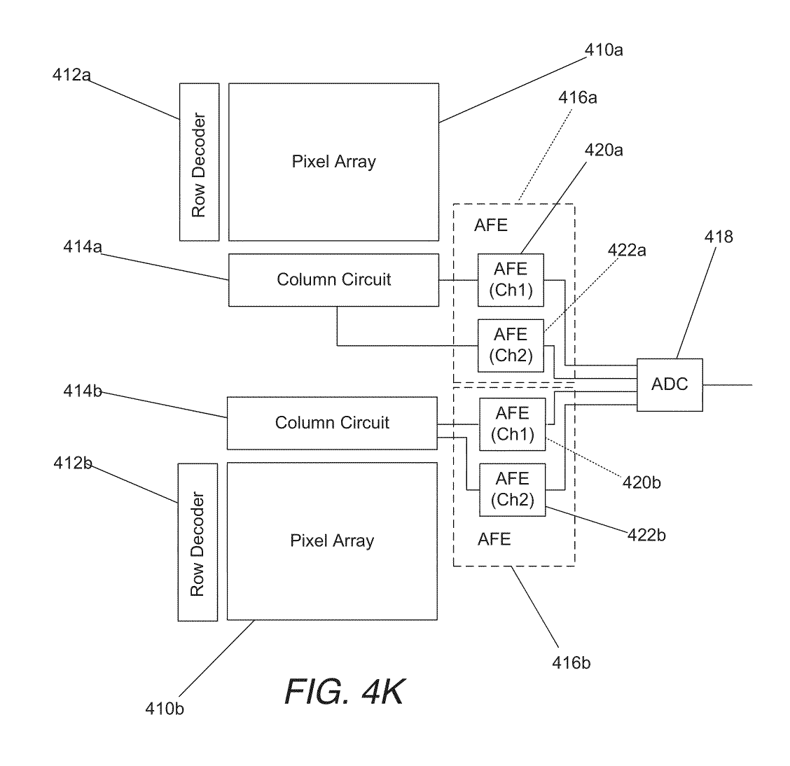

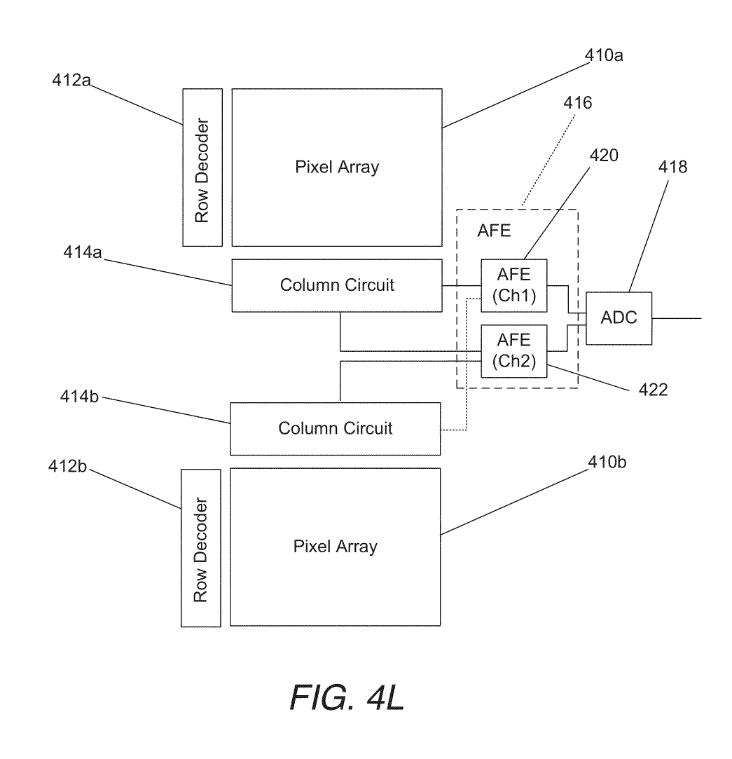

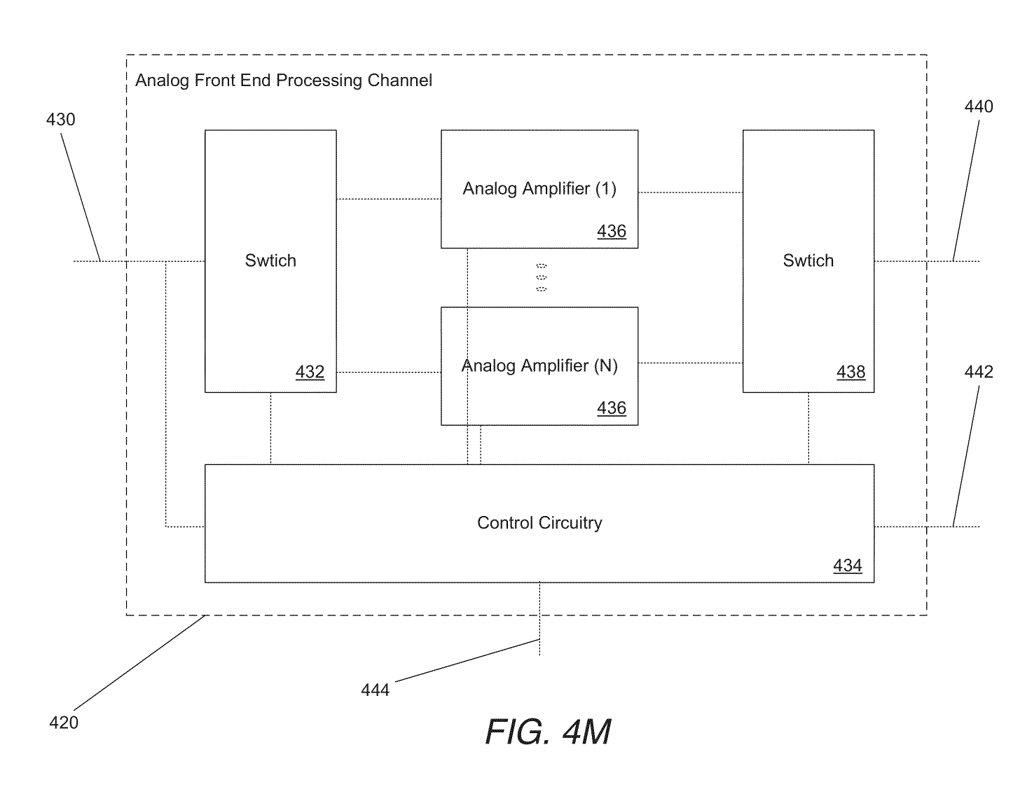

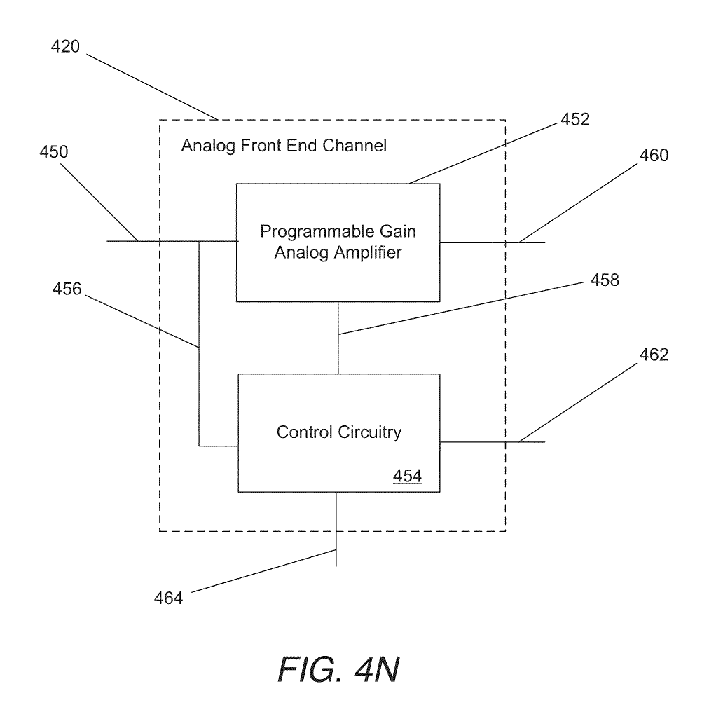

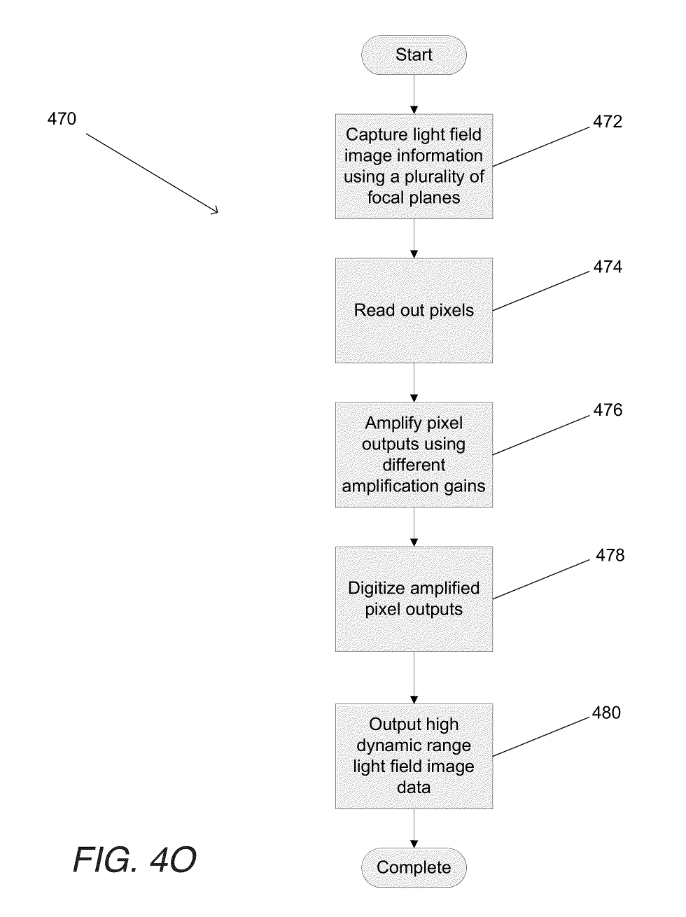

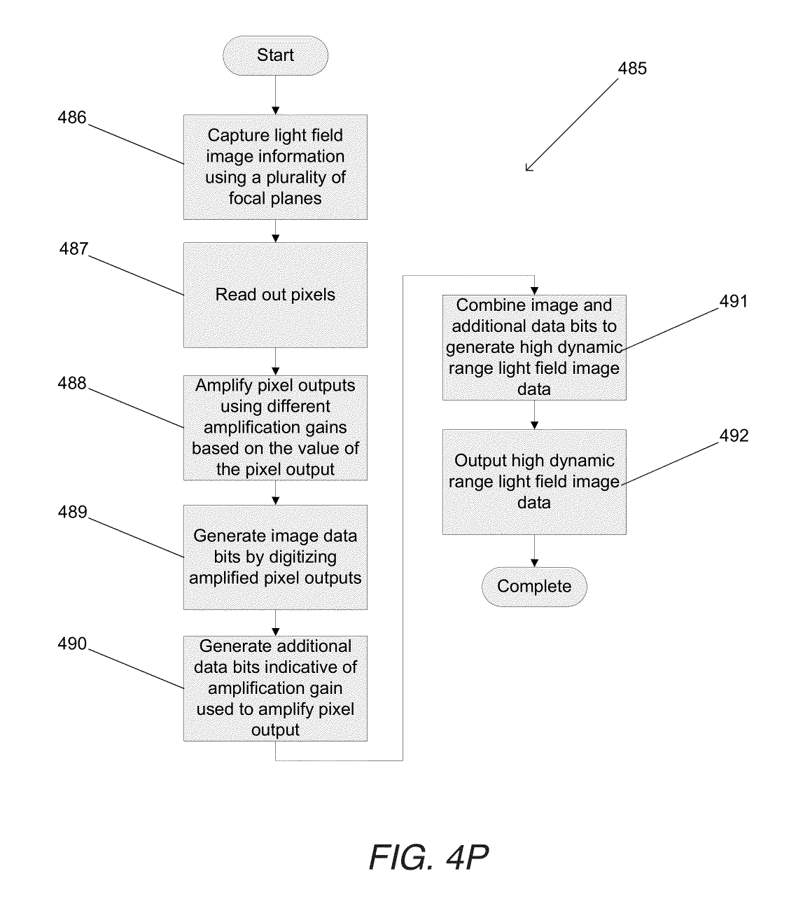

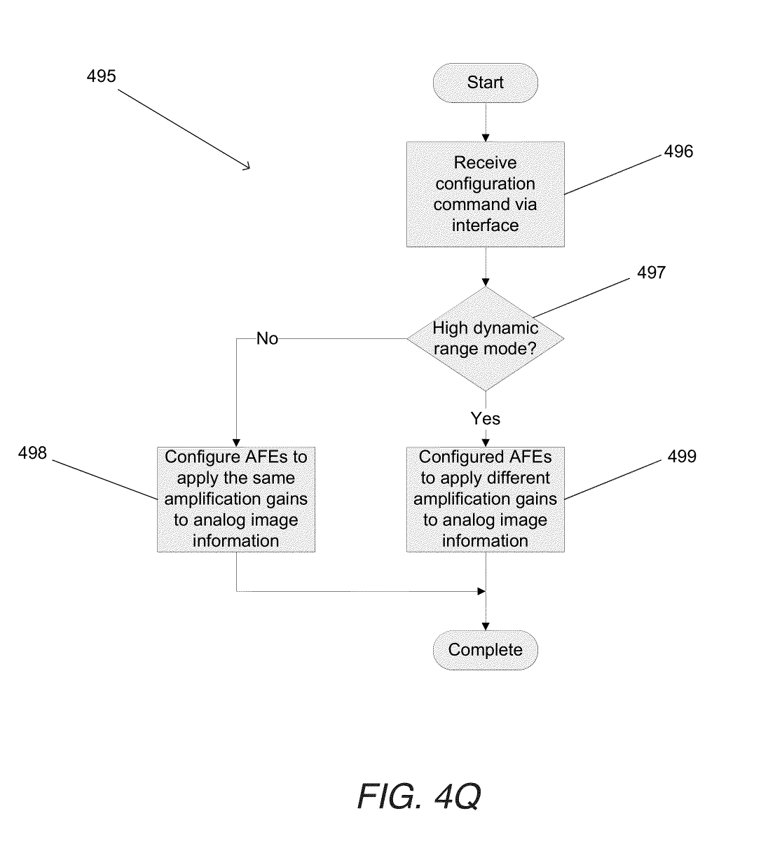

A focal plane within an imager array in accordance with an embodiment of the invention can be provided with a dedicated or shared AFE. In addition, the AFE can provide amplified analog image information to a dedicated or shared ADC. The number of AFE processing channels per focal plane and the type of analog amplifier incorporated within the AFE largely depend upon the requirements of a specific application. A focal plane including a dedicated AFE and ADC configured to enable the capture of high dynamic range image data in accordance with an embodiment of the invention is illustrated in FIG. 4I. The focal plane 410, which can be one of many in an imager array, includes a row decoder 412 and a column circuit 414 that are configured to select pixels from which analog image information is read out. The analog image information is provided to an AFE 416 that amplifies the analog image information using different amplification gains to create amplified high dynamic range analog image information. In many embodiments, specific amplification gains are applied to predetermined sets of pixels. In a number of embodiments, the amplification gains are applied to the same analog image information in parallel to provide multiple versions of the analog image information that can be selected for digital conversion and/or digitally converted and selected by a processor for use in the synthesis of a high resolution image. In several embodiments, the AFE applies amplification gains determined on a pixel by pixel basis. The amplified high dynamic range analog image information is provided by the AFE to the ADC and the ADC digitizes the amplified high dynamic range analog image information to create high dynamic range digital image data. In embodiments where the amplification gain applied to analog image information is determined on a pixel by pixel basis, the high dynamic range digital image data can include a number of data bits determined by digitizing the amplified high dynamic range analog image information and at least one additional bit that indicates the amplification gain applied to create the amplified high dynamic range analog image information.

Although a specific system for digitizing analog image information read out from a focal plane to obtain high dynamic range digital image data is illustrated in FIG. 4I, any of a variety of configurations of AFEs and ADCs can be utilized to obtain high dynamic range digital image data including systems that utilize AFEs including multiple AFE channels and systems that share AFEs and/or ADCs between focal planes.

A focal plane including a dedicated AFE including two AFE channels and a dedicated ADC that are configured to generate high dynamic range digital image data in accordance with an embodiment of the invention is illustrated in FIG. 4J. The system illustrated in FIG. 4J is similar to that illustrated in FIG. 4I. The AFE illustrated in FIG. 4J includes a first AFE processing channel 420 and a second AFE processing channel 422. The two AFE processing channels can both provide amplified high dynamic range analog image information to the dedicated ADC 418. The presence of two AFE processing channels means that predetermined sets of pixels can be read out and provided to each of the first and second AFE processing channels 420 and 422. The number of pixels per row (or column) that are connected to each AFE processing channel can be evenly divided or can be unevenly divided depending upon the requirements of a specific application. As discussed above, the gain of the analog amplifier in each of the AFE processing channels associated with a focal plane can be independently controlled to enable the capture of images with uniform analog gain or with increased dynamic range.

A focal plane including a dedicated AFE including two AFE channels, each having a dedicated ADC in accordance with an embodiment of the invention is illustrated in FIG. 4JA. The system illustrated in FIG. 4JA is similar to that illustrated in FIG. 4J with the exception that each AFE processing channel 420 and 422 includes a dedicated ADC 418 and 419.

Although specific systems for digitizing analog image information read out from a focal plane to obtain high dynamic range digital image data are illustrated in FIGS. 4J and 4JA, any of a variety of configurations of AFEs and ADCs can be utilized to obtain high dynamic range digital image data including systems that utilize AFEs including more than two AFE channels and systems that share AFEs and/or ADCs between focal planes.

As noted above, AFEs and AFE processing channels can be dedicated to a particular focal plane or shared between two or more focal planes. A pair of focal planes within an imager array that each have a dedicated AFE with a pair of AFE processing channels and that share an ADC in accordance with an embodiment of the invention is illustrated in FIG. 4K. Each focal plane includes a similar pixel array and read out circuitry to that shown in FIG. 4I. The focal planes 410a, 410b include associated row decoders 412a, 412b and column circuits 414a, 414b that read out analog image information from selected pixels. A dedicated AFE 416a, 416b is associated with each focal plane and each dedicated AFE includes a pair of AFE processing channels 420a, 420b. The outputs of each of the dedicated AFEs 416a, 416b is provided to a shared ADC 418. The dedicated AFEs 416a, 416b can use the pair of AFE processing channels 420a, 420b to apply different amplification gains to analog image information read out from different sets of pixels within the corresponding focal plane 410a, 410b. In a number of embodiments, a programmable gain analog amplifier is used to apply different amplification gains to analog image information read out from selected pixels in the focal planes 410a, 410b. The amplified high dynamic range analog image information generated by the dedicated AFEs 416a, 416b is provided to the shared ADC 418, which digitizes the amplified high dynamic range analog image information to create high dynamic range digital image data. As discussed above, the gain of the analog amplifier in each of the AFE processing channels associated with a focal plane can be independently controlled to enable the capture of images with uniform analog gain or with increased dynamic range.

Although a specific system for digitizing analog image information read out from focal planes in an imager array that share an ADC to obtain high dynamic range digital image data is illustrated in FIG. 4K, any of a variety of configurations of shared and/or dedicated AFEs and ADCs can be utilized to obtain high dynamic range digital image data including systems that share AFEs and ADCs between focal planes.

A pair of focal planes within an imager array that share an AFE including a pair of AFE processing channels and an ADC in accordance with an embodiment of the invention is illustrated in FIG. 4L. The configuration illustrated in FIG. 4L is similar to the configuration illustrated in FIG. 4K with the exception that the focal planes 410a, 410b utilize a shared AFE 416 including two AFE processing channels 420, 422. As pixels are selected by the read out circuitry of each focal plane 410a, 410b the analog image information is provided to one of the shared AFE processing channels. As described above, the AFE processing channel 420, 422 applies an amplification gain to the analog image information and the amplified analog image information is provided to the shared ADC 418 for conversion to digital image data. As discussed above, the gain of the analog amplifier in each of the AFE channels associated with a focal plane can be independently controlled to enable the capture of images with uniform analog gain or with increased dynamic range. High dynamic range images can be captured by applying different analog gains to the two sets of pixels processed by the two AFE processing channels. In the illustrated embodiment, the outputs of the AFE channels are provided to a shared ADC. In other embodiments, each focal plane can have a dedicated ADC, and/or the focal planes can share AFEs.

Although specific configurations of shared and dedicated AFEs are illustrated in FIGS. 4I-4L, any of a variety techniques can be used to modify the analog gain applied to pixel outputs and capture high dynamic range images in accordance with embodiments of the invention. In many embodiments, a single focal plane camera can utilize a single focal plane that includes two or more AFE processing channels in combination with one or more ADCs to capture high dynamic range image data in accordance with an embodiment of the invention. In a number of embodiments, some or all of the focal planes of an array camera can include two or more AFE processing channels.

The various AFEs discussed above can be implemented using multiple analog amplifiers that have fixed gains. In several embodiments, the AFEs can utilize programmable gain analog amplifiers and the amplification gain of the programmable gain analog amplifier can be programmed during image data capture. In this way, the imager array can be configured to operate in a standard image capture mode in which a uniform amplification gain is applied to the pixels read out from a given focal plane or a high dynamic range image capture mode in which different amplification gains are applied to the analog image information read out from the pixels in a given focal plane. Where the focal planes form part of an array camera configured to synthesize a higher resolution image based on the captured image data using super-resolution processing, greater resolution recovery can be offered in standard image capture mode and increased dynamic range can be offered in high dynamic range image capture mode. In embodiments where different amplification gains are applied on a pixel by pixel basis and/or where the analog image information read out form a pixel is provided to parallel AFE processing channels that apply different amplification gains the trade off between resolution and increased dynamic range may not be significant. In several embodiments, a programmable gain analog amplifier is utilized in which the amplification gain of the programmable gain analog amplifier is selected on a pixel by pixel basis based upon the output value of the analog image information read out from a pixel. Programmable gain analog amplifier that can be utilized to vary the amplification gain applied to the analog image information read out from pixels on a pixel by pixel basis are disclosed in U.S. Pat. No. 6,774,941, the disclosure of which is incorporated by reference herein in its entirety. The programmable gain analog amplifiers described in U.S. Pat. No. 6,774,941 can also be utilized in AFE processing channels where the same amplification gain is applied to the analog image information read out from pixels of a given focal plane during image capture by the focal plane and different amplification gains can be utilized during the capture of different images (i.e. the amplification gain can be changed, but does not change on a pixel by pixel basis during image capture).

An AFE processing channel including multiple analog amplifiers and control circuitry configured to switch the analog amplifier to which analog image information is provided on a pixel by pixel basis based upon the output value of the analog image information in accordance with an embodiment of the invention is illustrated in FIG. 4M. The AFE processing channel includes an analog image information input 430 on which analog image information is received. The analog image information is received via a switch 432 that is controlled by control circuitry 434. The control circuitry detects the output value of the analog image information and configures the switch to connect the input 430 to the input of an analog amplifier 436 with an amplification gain appropriate to the output value of the analog image information. In the illustrated embodiment, the AFE processing channel includes N analog amplifiers. In several embodiments, N can be two analog amplifiers. The output of the analog amplifiers 436 are connected to a second switch 438 and the control circuitry 434 switches the amplified analog image information output by the selected analog amplifier to an analog output 440. In several embodiments, the AFE processing channel 420 also includes a digital output 442 on which the control circuitry provides additional data bits that indicate the amplification gain that was applied to the amplified analog image information. In many embodiments, the control circuitry 434 is configured to receive a configuration command via a configuration command input 444. Based upon the configuration command, the control circuitry can configure the AFE processing channel so that the same amplification gain is applied to all analog image information received via the analog image information input 430 or so that the control circuitry determines the amplification gain applied to the analog image information received via the analog image information input 430 on a pixel by pixel basis. In several embodiments, one or more of the analog amplifiers are programmable gain analog amplifiers and the control circuitry is configured to determine the amplification gain applied by each of the programmable gain analog amplifiers.

A high analog gain can be applied to analog image information read out from a pixel with an output value that satisfies a low light threshold (for example, an amplitude below a threshold value) and a lower analog gain applied to analog image information read out from a pixel with an output value that does not satisfy the low light threshold (for example, an amplitude above a threshold value). In many embodiments, one or more comparators within the control circuitry 444 of the AFE processing channel 420 can determine the appropriate amplification gain to apply and a value indicating the amplification gain applied to the pixel can be output by the AFE control circuitry via the digital output 442. In this way, the focal plane is not separated into predetermined sets of high gain and low gain pixels (either based upon the AFE processing channel associated with the pixel or a predetermined pattern of pixels). Instead, the amplification gain applied to the analog image information read out from a pixel can be determined dynamically based on the pixel output value. In a number of embodiments, the AFE processing channel applies a single threshold to determine whether to apply a predetermined high gain value or a predetermined lower gain value. The gain applied to the pixel can be output as a single bit of information that is associated with the digitized pixel data following analog-to-digital conversion of the amplified analog image information by an ADC to create digital image data.

Although specific AFE processing channels incorporating multiple analog amplifiers and control circuitry configured to switch analog image information between the analog amplifiers on a pixel by pixel basis based upon the output value of the analog image information are described above with reference to FIG. 4M, any of a variety of AFE processing channels can be utilized to vary the amplification gain applied to analog image information on a pixel by pixel basis including AFE processing channels that include a programmable gain analog amplifier in which the amplification gain of the programmable gain analog amplifier is determined on a pixel by pixel basis based upon the output value of the analog image information read out from a pixel.

An Analog Front End including an programmable gain analog amplifier and control circuitry configured to determine the gain of the analog amplifier on a pixel by pixel basis based upon the output value of the analog image information read out from a pixel in accordance with an embodiment of the invention is illustrated in FIG. 4N. The AFE processing channel 420 includes an analog image information input 450 via which the AFE processing channel 420 receives analog image information read out from pixels in a focal plane of an imager array. The analog image information is provided to a programmable gain analog amplifier 452. Control circuitry detects the output value of the analog image information read out from a pixel via a connection 456 with the analog image information input 450. The control circuitry determines the gain of the programmable gain analog amplifier and can adjust the gain of the programmable gain analog amplifier on a pixel by pixel basis based upon the output value of the analog image information read out from a pixel using a control connection 458. The programmable gain analog amplifier outputs the amplified analog image information via the analog output 460. In several embodiments, the AFE processing channel 420 also includes a digital output 462 on which the control circuitry provides additional data bits that indicate the amplification gain that was applied to the amplified analog image information. In many embodiments, the control circuitry 454 is configured to receive a configuration command via a configuration command input 464. Based upon the configuration command, the control circuitry can configure the AFE processing channel so that the same amplification gain is applied to all analog image information received via the analog image information input 450 or so that the control circuitry determines the amplification gain applied to the analog image information received via the analog image information input 450 on a pixel by pixel basis. When the amplification gain is determined on a pixel by pixel basis, a high amplification gain can be applied to analog image information read out from a pixel with an output value that satisfies a low light threshold (for example, an amplitude below a threshold value) and a lower amplification gain applied to analog image information read out from a pixel with an output value that does not satisfy the low light threshold (for example, an amplitude above a threshold value). In many embodiments, one or more comparators within the control circuitry 454 of the AFE processing channel 420 can determine the appropriate amplification gain to apply and a value indicating the amplification gain applied to the pixel can be output by the AFE control circuitry via the digital output 462.

Although specific configurations of AFE processing channels incorporating programmable gain analog amplifiers that can apply different amplification gains to analog image information on a pixel by pixel basis are discussed above with respect to FIG. 4N, any of a variety of AFE processing channels incorporating programmable gain analog amplifiers that can apply different amplification gains to analog image information on a pixel by pixel basis can be utilized as appropriate to the requirements of a specific application in accordance with embodiments of the invention.

In additional embodiments, an AFE is configured to apply different gains that could be applied (during pixel readout) during the readout of black pixels, which are used to calibrate the pixel and amplifier's offset levels. A black pixel is typically constructed by placing pixel in a region of an imager array that is shielded from light. In many embodiments, a light shield can be created using an opaque material formed using (but not limited to) epoxy, paint, glue, metal, and/or oxide. In this way, carriers formed within a black pixel are not created by light and instead are indicative of noise processes within the imager array. Therefore, black pixel information can be utilized in adjusting the analog image information read from active pixels to account for dark noise in the imager array. Rather than the pixel level of the black pixel being used to determine the amplification gain applied to the black pixel information output by the black pixel, in many embodiments of the invention the amplifier gain applied to the black pixel information is switched in a deterministic fashion such that calibration circuitry can measure the offset level of the signal path corresponding to all the amplification gain settings that may be used in active pixel readout. This enables a black level compensation value to be pre-determined such that during readout of active pixels, the appropriate black level offset value can be used to compensate each pixel based on the amplification gain that was applied to the active pixel during readout. Depending on the amplification of the analog image information and the number of bits of precision available in the ADC, the black pixel offset can be applied to the amplified analog image information (where additional bits are available in the ADC) or the black pixel offset can be applied digitally following conversion of the amplified analog image information to digital image data by the ADC.

### 4.3.6. Methods of Capturing High Dynamic Range Light Field Image Data

High dynamic range light field image data can be captured using an array camera including a camera module constructed using an imager array similar to the imager arrays described above that can apply different amplification gains to analog image information read out from pixels within a given focal plane within the imager array. A method for obtaining high dynamic range light field image data in accordance with an embodiment of the invention is illustrated in FIG. 4O. The process 470 includes capturing (472) light field image information using an imager array that includes a plurality of focal planes. Analog image information is read out (474) from pixels in the focal planes and different amplification gains are applied (476) to the analog image information read out from pixels within a given focal plane. In several embodiments, the amplification gain is determined based upon the specific pixel that is being read out. In a number of embodiments, the amplification gain is determined based upon the output value of the analog image information read out from a pixel. The application of different amplification gains to the analog image information creates amplified high dynamic range image information that is digitized (478) by one or more ADCs to create high dynamic range digital image data. In embodiments where the amplification gain is determined on a pixel by pixel basis based upon the output value of the analog image information read out from a pixel, the high dynamic range digital image data includes a number of image data bits and at least one additional data bit that indicates the amplification gain applied to the analog image information prior to digitization. High dynamic range light field image data including the high dynamic range digital image data obtained from each of the pixels can then be output (482) to an external device.

Although specific processes for capturing high dynamic range light field image data are discussed above with respect to FIG. 4O, any of a variety of processes can be utilized to capture high dynamic range light field image data as appropriate to the requirements of a specific application including processes that apply different amplification gains on a pixel by pixel basis in accordance with embodiments of the invention.

A method of obtaining high dynamic range light field image data in which the amplification gain applied to analog image information is determined on a pixel by pixel basis in accordance with an embodiment of the invention is illustrated in FIG. 4P. The process 485 includes capturing (486) light field image information using an imager array that includes a plurality of focal planes. Analog image information is read out (487) from pixels in the focal planes and different amplification gains are applied (488) to the analog image information read out from pixels within a given focal plane based upon the output value of the analog image information read out from the pixel. The application of different amplification gains to the analog image information creates amplified high dynamic range image information that is digitized (489) by one or more ADCs to create high dynamic range digital image data. In addition, one or more additional data bits can be generated to indicate the amplification gain applied to the analog image information prior to digitization. The image data bits and the additional data bits are combined (491) to create high dynamic range light field image data that can be output (492) to an external device.

Although specific processes for capturing high dynamic range light field image data in which different amplification gains are applied to analog image information read out from pixels in a given focal plane on a pixel by pixel basis based on the output value of the analog image information are described above with respect to FIG. 4P, any of a variety of processes can be utilized for producing high dynamic range light field image data by adjusting the amplification gains applied to individual pixels as appropriate to the requirements of a specific application in accordance with embodiments of the invention.

As noted above, the analog gains applied to the analog image information read out from pixels in a focal plane can be modified depending upon whether the array imager is attempting to capture images at the highest possible resolution or with the largest dynamic range. A standard image capture mode can be utilized in which the same analog gain is applied to the analog image information read out of all of the pixels sampled by the AFE processing channel(s) in the AFE. The benefit of using the same analog gain with respect to all of the pixels read out from a focal plane is that typically higher resolution recovery can be achieved during super-resolution processing. Where increased dynamic range is desirable due to variation in lighting conditions, a high dynamic range image capture mode can be utilized in which different analog gains can be applied to the pixel samples in a predetermined manner or on a pixel by pixel basis. In embodiments where different amplification gains are applied on a pixel by pixel basis and/or where the analog image information read out form a pixel is provided to parallel AFE processing channels that apply different amplification gains the trade off between resolution and increased dynamic range may not be significant. The application of different amplification gains to the analog image information read out from pixels within a given focal plane can reduce the increase in resolution that can be achieved using super-resolution processing.

In array cameras that include a large number of focal planes (such as those described above with respect to FIGS. 2A and 2B), a sufficient amount of image data may be available to the array camera to achieve acceptable increases in resolution and high dynamic range color information. In many embodiments, the array camera can independently control the capture mode of individual focal planes so that a number of focal planes are utilized in standard image capture mode to obtain a sufficient amount of digital image data using consistent amplification gains to achieve a desired increase in resolution when synthesizing a higher resolution image using super-resolution processing and one or more focal planes can be utilized in high dynamic range image capture mode to capture digital image data providing additional color information.

In a number of embodiments, the location of the focal planes that are configured in high dynamic range image capture mode can be determined based upon the focal plane (or virtual viewpoint) that is used as a reference camera during the synthesis of a higher resolution image using super resolution processing. The reference focal plane is typically used in standard image capture mode and focal planes configured in high dynamic range image capture mode can be located above, below, to the left, and to the right of the reference focal plane in the imager array. In this way, the likelihood of occlusions in the high dynamic range image data when shifted into the viewpoint of the reference focal plane is reduced. In a number of embodiments, the reference focal plane, and at least one focal plane located above, below, to the left, and to the right of the reference focal plane in the imager array are configured in standard image capture mode and additional focal planes in the imager array can be configured in high dynamic range image capture mode. In embodiments where the imager array is part of a camera module configured as an array of cameras configured to capture different colors of light similar constraints can be placed on the focal planes in the imager array that are configured in standard image capture mode and high dynamic range image capture mode on a color channel by color channel basis to limit the likelihood that there are occlusions when the high dynamic range image data in each of the color channels is shifted into the viewpoint of the reference camera. As can readily be appreciated, the decision concerning the focal planes to operate in standard image capture mode and the focal planes to operate in high dynamic range image capture mode largely depend on the requirements of a specific application. Accordingly, any of a variety of focal plane image capture mode configurations can be utilized to synthesize a high resolution image incorporating high dynamic range image data using super-resolution processes in accordance with embodiments of the invention.

A method of configuring a focal plane of an imager array using a standard image capture mode and a high dynamic range image capture mode in accordance with an embodiment of the invention is illustrated in FIG. 4Q. The process 495 includes receiving (496) a configuration command using the imager array interface via which the imager array communicates with external devices. In response to the configuration command, the imager array determines (497) whether the focal plane is operated in high dynamic range mode. As noted above, the fact that an imager array is instructed to capture high dynamic range information does not necessarily mean that all focal planes and consequently any specific focal plane is operated in high dynamic range image capture mode. In several embodiments, the focal planes that are operated in high dynamic range image capture mode in response to a configuration command to capture high dynamic range image data is predetermined. In a number of embodiments, the focal planes that are operated in high dynamic range image capture mode in response to a configuration command to capture high dynamic range image data is determined in real time based upon the characteristics of the scene. When a focal plane is configured (498) in standard image capture mode, the AFE associated with the focal plane is configured to apply the same amplification gain to the analog image information read out from the pixels of the focal plane. When a focal plane is configured (499) in high dynamic range image capture mode, the AFE associated the focal plane is configured to apply different amplification gains to the analog image information read out from different pixels within the focal plane. As can readily be appreciated, sharing of AFEs and/or AFE channels between focal planes can constrain the extent to which the two (or more) focal planes that share the AFE can be configured to operate in different image capture modes. In embodiments where the AFE include programmable gain analog amplifiers that can adjust the amplification gain of the programmable gain analog amplifiers on a pixel by pixel basis, focal planes that share the AFE can be configured to operate in different image capture modes. In embodiments where the amplification gain is determined on a pixel by pixel basis based upon the output value of the analog image information read out from a pixel, the high dynamic range light field image data output by the image sensor can include additional data indicating the image capture mode utilized during the capture of the high dynamic range light field image data. Furthermore, the high dynamic range light field image data output by the image sensor can include additional data indicating the specific focal planes that captured high dynamic range image data.

Although specific processes for configuring the image capture mode of a focal plane in an imager array are discussed above with respect to FIG. 4Q, any of a variety of processes for configuring focal planes of an imager array to operate in at least a standard image capture mode and a high dynamic range image capture mode can be utilized as appropriate to the requirements of a specific application in accordance with an embodiment of the invention.

While specific techniques for capturing high dynamic range information are discussed above, each of the techniques can be applied in combination for capturing high dynamic range images. In addition, the techniques described above can be utilized in combination with other techniques for capturing high dynamic range images as appropriate to the requirements of a specific application.

### 4.4. Peripheral Circuitry

In a conventional imager, pixels are typically accessed in a row-wise fashion using horizontal control lines that run across each row of pixels. Output signal lines that run vertically through each pixel are used to connect the pixel output to a sampling circuit at the column periphery. The horizontal control lines and the output signal lines are typically implemented as metal traces on silicon. The outputs from all pixels in a row are simultaneously sampled at the column periphery, and scanned out sequentially using column controllers. However, common row-wise access along the full row of K pixels in an imager array does not enable the imagers to be read out independently. As noted above, many of the benefits of utilizing an imager array derive from the independence of the focal planes and the ability for the imager array to separately control the capture of image information by the pixels in each focal plane. The ability to separately control the capture of information means that the capture of image information by the pixels in a focal plane can be customized to the spectral band the focal plane is configured to capture. In a number of embodiments, the ability to provide separate trigger times can be useful in synchronizing the capture of image data using focal planes that have different integration times and in capturing sequences of images that can be registered to provide slow motion or high frame rate video sequences. In order to control the capture of image information by different focal planes within an imager array, independent read-out control can be provided for each focal plane. In several embodiments, the imager array has independent read-out control due to the fact that each focal plane has an associated row (column) controller, column (row) read-out circuits and a dedicated AFE and ADC. In many embodiments, separate control of the capture of image information by pixels in different focal planes is achieved using peripheral circuitry that is shared between focal planes. Imager arrays implemented using dedicated peripheral circuitry and shared peripheral circuitry in accordance with embodiments of the invention are discussed below.

### 4.4.1. Dedicated Peripheral Circuitry

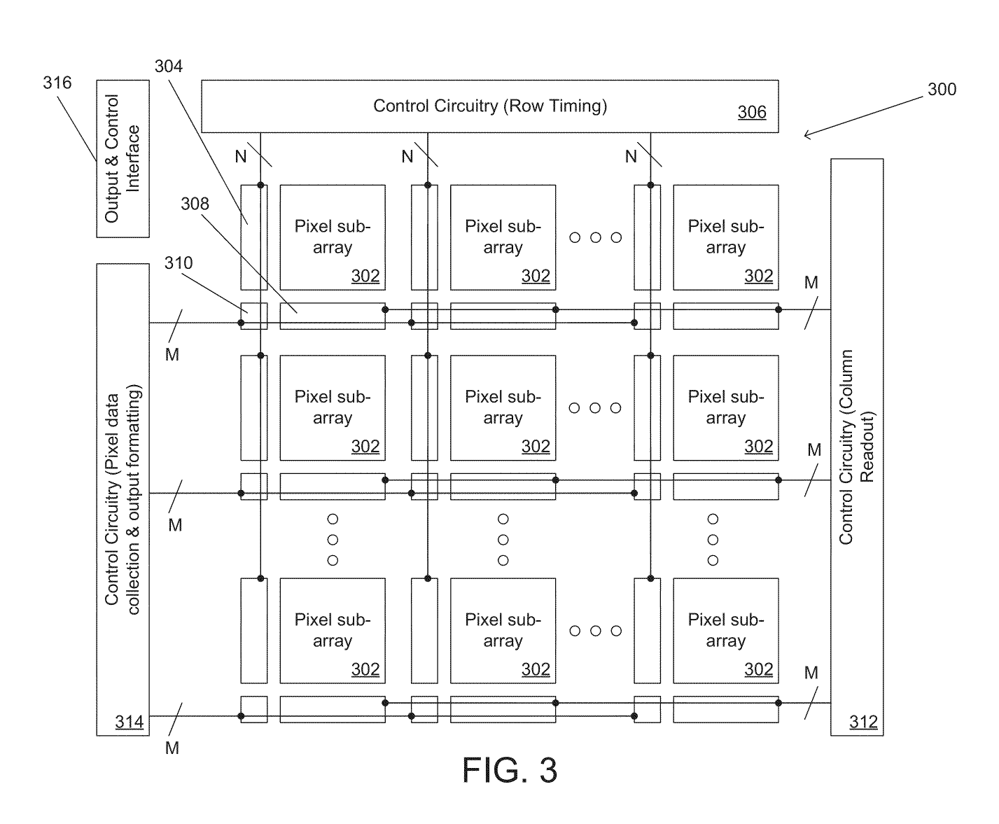

An imager array including multiple focal planes having independent read-out control and pixel digitization, where each focal plane has dedicated peripheral circuitry, in accordance with embodiments of the invention is illustrated in FIG. 3. The imager array 300 includes a plurality of sub-arrays of pixels or focal planes 302. Each focal plane has dedicated row control logic circuitry 304 at its periphery, which is controlled by common row timing control logic circuitry 306. Although the column circuits and row decoder are shown as a single block on one side of the focal plane, the depiction as a single block is purely conceptual and each logic block can be split between the left/right and/or top/bottom of the focal plane so as to enable layout at double the pixel pitch. Laying out the control and read-out circuitry in this manner can result in a configuration where even columns are sampled in one bank of column (row) circuits and odd columns would be sampled in the other.

In a device including M×N focal planes, the read-out control logic includes M sets of column control outputs per row of focal planes (N). Each column sampling/read-out circuit 308 can also have dedicated sampling circuitry for converting the captured image information into digital pixel data. In many embodiments, the sampling circuitry includes Analog Signal Processor (ASP), which includes an Analog Front End (AFE) amplifier circuit and an Analog to Digital Converter (ADC) 310. In other embodiments, any of a variety of analog circuitry can be utilized to convert captured image information into digitized pixel information. An ASP can be implemented in a number of ways, including but not limited to, as a single ASP operating at X pixel conversion per row period, where X is the number of pixels in a row of the focal plane served by the column sampling circuit (e.g. with a pipe-lined or SAR ADC), as X ASPs operating in parallel at 1 pixel conversion per row period or P ASPs operating in parallel at X/P conversions per row (see discussion below). A common read-out control circuit 312 controls the read-out of the columns in each imager.

In the illustrated embodiment, the master control logic circuitry 314 controls the independent read-out of each imager. The master control logic circuitry 314 includes high level timing control logic circuitry to control the image capture and read-out process of the individual focal plane. In a number of embodiments, the master control portion of this block can implement features including but not limited to: staggering the start points of image read-out such that each focal plane has a controlled temporal offset with respect to a global reference; controlling integration times of the pixels within specific focal planes to provide integration times specific to the spectral bandwidths being imaged; the horizontal and vertical read-out direction of each imager; the horizontal and vertical sub-sampling/binning/windowing of the pixels within each focal plane; the frame/row/pixel rate of each focal plane; and the power-down state control of each focal plane.

The master control logic circuitry 314 handles collection of pixel data from each of the imagers. In a number of embodiments, the master control logic circuitry packs the image data into a structured output format. Given that fewer than M×N output ports are used to output the image data (e.g. there are 2 output ports), the imager data is time multiplexed onto these output ports. In a number of embodiments, a small amount of memory (FIFO) is used to buffer the data from the pixels of the imagers until the next available time-slot on the output port 316 and the master control logic circuitry 314 or other circuitry in the imager array periodically inserts codes into the data stream providing information including, but not limited to, information identifying a focal plane, information identifying a row and/or column within a focal plane, and/or information identifying the relative time at which the capture or read-out process began/ended for one or more of the focal planes. Relative time information can be derived from an on-chip timer or counter, whose instantaneous value can be captured at the start/end of read-out of the pixels from each imager either at a frame rate or a line rate. Additional codes can also be added to the data output so as to indicate operating parameters such as (but not limited to) the integration time of each focal plane, and channel gain and the image capture mode. As is discussed further below, the host controller can fully re-assemble the data stream back into the individual images captured by each focal plane and/or can perform super-resolution processing or the captured image data to synthesize a high resolution image. In several embodiments, the imager array includes sufficient storage to buffer at least a complete row of image data from all focal planes so as to support reordering and or retiming of the image data from all focal planes such that the data is always packaged with the same timing/ordering arrangement regardless of operating parameters such as (but not limited to) integration time and relative read-out positions. In a number of embodiments, the imager array includes sufficient storage to buffer at least a complete line of image data from all focal planes so as to support reordering and or retiming of the image data from all focal planes such that the data is packaged in a convenient manner to ease the host's reconstruction of the image data, for example retiming/reordering the image data to align the data from all focal planes to a uniform row start position for all focal planes irrespective of relative read-out position.

### 4.4.2. ASP Sharing

The imager array illustrated in FIG. 3 includes a separate ASP associated with each focal plane. An imager array can be constructed in accordance with embodiments of the invention in which ASPs or portions of the ASPs such as (but not limited to) the AFE or the ADC are shared between focal planes. An imager array that shares ASPs between multiple focal planes in accordance with embodiments of the invention is illustrated in FIG. 4. The imager array 300′ utilizes an ASP 310′ for sampling of all the pixels in one column of the M×N array of focal planes. In the illustrated embodiment, there are M groups of analog pixel signal read-out lines connected to M ASPs. Each of the M groups of analog pixel signal read-out lines has N individual lines. Each of the M ASPs sequentially processes each pixel signal on its N inputs. In such a configuration the ASP performs at least N processes per pixel signal period of the N inputs given that each focal plane at its input is in an active state. If one or more of an ASP's focal plane inputs is in an inactive or power down state, the processing rate could be reduced (so as to achieve a further saving in power consumption) or maintained (so as to achieve an increase in frame rate). Alternatively, a common single analog pixel signal read-out line can be shared by all column circuits in a column of focal planes (N) such that the time multiplexing function of the ASP processing can be implemented through sequencing controlled by the column read-out control block 312′.

Although the imager array illustrated in FIG. 4 includes shared ASPs, imager arrays in accordance with many embodiments of the invention can include dedicated AFEs and share ADCs. In other embodiments, the sharing ratios of the AFE and ADC do not follow the same number of focal planes. In several embodiments, each focal plane may have a dedicated AFE but two or more AFE outputs are input to a common ADC. In many embodiments, two adjacent focal planes share the same AFE and one or more of these focal plane couples would then be input into an ADC. Accordingly, AFEs and ADCs can be shared between different focal planes in a SOC imager any of a variety of different ways appropriate to specific applications in accordance with embodiments of the invention.

Sharing of ADCs between pairs of focal planes in an imager array in accordance with embodiments of the invention is illustrated in FIG. 4D. In the illustrated embodiment, the sharing of ADCs between pairs of focal planes can be replicated amongst multiple pairs of focal planes within an imager array. Sharing of AFEs between pairs of focal planes and sharing of ADCs between groups of four focal planes in an imager array in accordance with embodiments of the invention is illustrated in FIG. 4E. The sharing of AFEs and ADCs illustrated in FIG. 4E can be replicated amongst multiple groups of four focal planes within an imager array. In many embodiments, sharing occurs in pairs of focal planes and/or groups of three or more focal planes.

In many embodiments, the pixels within each focal plane are consistently processed through the same circuit elements at all times such that they have consistent offset and gain characteristics. In many embodiments, the control and read-out circuits and AFE are controlled by a common clocking circuit such that the phases and time slot assignment of each focal plane are consistent. An example of the phase shift between the column read-out of the different focal planes in accordance with embodiments of the invention is illustrated in FIG. 4C. As can be seen, the read-out of the columns in each focal plane is staggered to enable processing by a shared ASP in accordance with embodiments of the invention.

In order to support a reduction of power when certain focal planes are not imaging, the ASP, clocking, and bias/current schemes utilized within the imager array can support multiple sample rate configurations such that the sampling rate is always P times the pixel rate of a single focal plane, where P is the number of active focal planes being processed/sampled.

A rotated variation of the resource sharing architecture illustrated in FIG. 4 can also be implemented whereby a single ASP is shared among all pixels in a row of M×N (rather than in a column of M×N). Such an arrangement would, therefore, involve use of N ASPs each having M inputs or a single input that is common to the M focal planes, and time-multiplexed by the column read-out control block using sequencing control.

### 4.4.3. Column Circuit Sharing

In another embodiment of the invention, fewer than M×N column circuits are used for sampling the pixel values of the focal planes in an imager array. An imager array 301 configured so that individual focal planes within a column of the imager array share a common column circuit block 308′ such that the device utilizes only M sets of column circuits in accordance with an embodiment of the invention is illustrated in FIG. 4A. The M column circuits are accompanied by M ASPs 310′.

In several embodiments, the column circuits are time shared such that they enable read-out of pixels from focal planes above and below the column circuit. Sharing of a column circuit between pairs of focal planes within an imager array in accordance with embodiments of the invention is illustrated in FIG. 4F. The sharing shown in FIG. 4F is the special case in FIG. 4A, where M=2. Due to the sharing of the column circuit between the pair of focal planes, the column circuit operates at twice the rate than the desired frame rate from a single focal plane. In many embodiments, the pixels are correlated double sampled and read-out either in their analog form or analog to digital converted within the column circuit. Once the last pixel has been shifted out (or the analog to digital conversion of all the columns has been performed), the column circuit can be reset to remove residual charge from the previous pixel array. A second time slot can then be used for the same operation to occur for the second focal plane. In the illustrated embodiment, the sharing of ADCs between pairs of focal planes can be replicated amongst multiple pairs of focal planes within an imager array.

In other embodiments, variations on the imager array 301 illustrated in FIG. 4A can utilize more or fewer ASPs. In addition, the column circuits 308′ can be divided or combined to form more or fewer than M analog outputs for digitization. For example, an imager array can be designed such that there is a single ASP used for digitization of the M column circuits. The M outputs of the column circuits are time multiplexed at the input to the ASP. In the case that more than M ASPs are used, each of the M column circuits are further divided such that each column circuit has more than one analog output for digitization. These approaches offer trade-offs between silicon area and power consumption since the greater the number of ASPs, the slower each ASP can be so as to meet a target read-out rate (frame rate).

A structural modification to the embodiment illustrated in FIG. 4A is to split the M column circuits between the top and bottom of the imager array such that there are M×2 column circuit blocks. In such a modification each of the M×2 column circuits is responsible for sampling only half of the pixels of each focal plane in the column of focal planes (e.g. all even pixels within each focal plane could connect to the column circuit at the bottom of the array and all odd pixels could connect to the column circuit at the top). There are still M×X column sampling, circuits, however they are physically divided such that there are M×2 sets of λ/2 column sampling circuits. An imager array including split column circuits in accordance with an embodiment of the invention is illustrated in FIG. 4B. The imager array 301′ uses M×2 column circuit blocks (308a′, 308b′) and M×2 ASPs (310a′, 310b′). As discussed above, there can also be fewer or more ASPs than the M×2 column circuits. Another variation involving splitting column circuits in accordance with embodiments of the invention is illustrated in FIG. 4G in which the column circuit is split into top/bottom for sampling of odd/even columns and interstitial column circuits are time shared between the focal planes above and below the column circuits. In the illustrated embodiment, the splitting of column circuits and sharing of column circuits between pairs of focal planes is replicated amongst multiple pairs of focal planes within an imager array in accordance with embodiments of the invention. In addition, each of the column circuits can be shared between an upper and lower focal plane (with the exception of the column circuits at the periphery of the imager array).

### 4.4.4. Number and Rate of ASPs

There are a number of different arrangements for the column sampling circuitry of imager arrays in accordance with embodiments of the invention. Often, the arrangement of the ASP circuitry follows a logical implementation of the column sampling circuits such that a single ASP is used per column circuit covering X pixels thus performing X conversions per row period. Alternatively, X ASPs can be utilized per column circuit performing one conversion per row period. In a general sense, embodiments of the invention can use P ASPs per column circuit of X pixels such that there are X/P conversions per row period. This approach is a means by which the conversion of the samples in any column circuit can be parallelized such that the overall ADC conversion process occurs at a slower rate. For example, in any of the configurations described herein it would be possible to take a column circuit arrangement that samples a number of pixels (T) and performs the analog-to-digital conversion using P ASPs, such that there are T/P conversions per row period. Given a fixed row period (as is the case with a fixed frame rate) the individual conversion rate of each ASP is reduced by the factor P. For example, if there are two ASPs, each runs at ½ the rate. If there are four, each ASP has to run at ¼ the rate. In this general sense, any number of ASPs running at a rate appropriate to a specific application irrespective of the configuration of the column circuitry can be utilized in accordance with embodiments of the invention.

### 4.4.5. Row Decoder Optimization

Imager arrays in accordance with embodiments of the invention possess the ability to access different rows within each focal plane at a given instant so as to enable separate operating parameters with respect to the capture of image information by the pixels of each focal plane. The row decoder is typically formed from a first combinational decode of a physical address (represented as an E bit binary number) to as many as 2^{E} “enable” signals (often referred to as a “one-hot” representation). For example, an 8 bit physical address is decoded into 256 “enable” signals so as to support addressing into a pixel array having 256 rows of pixels. Each of these “enable” signals are in turn logically ANDED with pixel timing signals, the results of which are then applied to the pixel array so as to enable row based pixel operations such as pixel reset and pixel charge transfer.

The row decoders can be optimized to reduce silicon area through sharing of the binary to one-hot decode logic. Rather than each sub-array having a fully functional row decoder, including binary to one-hot decoding, many embodiments of the invention have a single binary to one-hot decoder for a given row of focal planes within the imager array. The “enable” outputs of this decoder are routed across all focal planes to each of the (now less functional) row decoders of each focal plane. Separate sets of pixel level timing signals would be dedicated to each focal plane (generated by the row timing and control logic circuitry) and the logical AND function would remain in each focal plane's row decoder.

Readout with such a scheme would be performed in time slots dedicated to each focal plane such that there are M timeslots per row of focal planes in the camera array. A first row within the first focal plane would be selected and the dedicated set of pixel level timing signals would be applied to its row decoder and the column circuit would sample these pixels. In the next time slot the physical address would change to point to the desired row in the next focal plane and another set of dedicated pixel level timing signals would be applied to its row decoder. Again, the column circuits would sample these pixels. The process would repeat until all focal planes within a row of focal planes in the camera array have been sampled. When the column circuits are available to sample another row from the imager array, the process can begin again.

### 4.5. Providing a Memory Structure to Store Image Data

An additional benefit of the separate control of the capture of image information by each focal plane in an imager array is the ability to support slow motion video capture without increasing the frame rate of the individual focal planes. In slow motion video each focal plane is read out at a slightly offset point in time. In a traditional camera, the time delta between frames (i.e. the capture frame rate) is dictated by the read-out time of a single frame. In an imager array offering support of independent read-out time of the individual focal planes, the delta between frames can be less than the read-out of an individual frame. For example, one focal plane can begin its frame read-out when another focal plane is halfway through the read-out of its frame. Therefore an apparent doubling of the capture rate is achieved without requiring the focal planes to operate at double speed. However, when outputting the stream of images from the camera, this overlapping frame read-out from all focal planes means that there is continuous imagery to output.

Camera systems typically employ a period of time between read-out or display of image data known as the blanking period. Many systems require this blanking period in order to perform additional operations. For example, in a CRT the blanking interval is used to reposition the electron beam from the end of a line or frame to the beginning of the next line or frame. In an imager there are typically blanking intervals between lines to allow the next line of pixels to be addressed and the charge therein sampled by a sampling circuit. There can also be blanking intervals between frames to allow a longer integration time than the frame read-out time.

For an array camera operating in slow motion capture mode in accordance with an embodiment of the invention, the frame read-out is offset in time in all the focal planes such that all focal planes will enter their blanking intervals at different points in time. Therefore, there typically will not be a point in time where there is no image data to transmit. Array cameras in accordance with embodiments of the invention can include a retiming FIFO memory in the read-out path of the image data such that an artificial blanking period can be introduced during transmission. The retiming FIFO temporarily stores the image data to be transmitted from all the focal planes during the points in time where a blanking interval is introduced.

### 4.6. Imager Array Floor Plan

Imager arrays in accordance with embodiments of the invention can include floor plans that are optimized to minimize silicon area within the bounds of certain design constraints. Such design constraints include those imposed by the optical system. The sub-arrays of pixels forming each focal plane can be placed within the image circle of each individual lens stack of the lens array positioned above the imager array. Therefore, the manufacturing process of the lens elements typically imposes a minimum spacing distance on the imagers (i.e. a minimum pitch between the focal planes). Another consideration in the focal spacing coming from optical constraints is the magnitude of stray light that can be tolerated. In order to limit optical cross-talk between focal planes, many camera arrays in accordance with embodiments of the invention optically isolate the individual focal planes from each other. An opaque barrier can be created between the optical paths of adjacent focal planes within the lens stack. The opaque barrier extends down to the sensor cover-glass and can serve the additional purpose of providing a sensor to optics bonding surface and back focus spacer. The incursion of the opaque shield into the imaging circle of the lens can result in some level of reflection back into the focal plane. In many embodiments, the complex interplay between the optics and the imager array results in the use of an iterative process to converge to an appropriate solution balancing the design constraints of a specific application.

The space between the focal planes (i.e. the spacing distance) can be used to implement control circuitry as well as sampling circuitry including (but not limited to) ASP circuits or other circuitry utilized during the operation of the imager array. The logic circuits within the imager array can also be broken up and implemented within the spacing distance between adjacent focal planes using automatic place and routing techniques.

Although specific constraints upon the floor plans of imager arrays are described above, additional constraints can be placed upon floor plans that enable the implementation of the various logic circuits of the imager array in different areas of the device in accordance with embodiments of the invention. In many embodiments, requirements such as pixel size/performance, the optical system of the array camera, the silicon real-estate cost, and the manufacturing process used to fabricate the imager array can all drive subtle variations in the imager array overall architecture and floor plan.

### 4.6.1. Sampling Diversity

In many embodiments, the floor plan also accommodates focal planes that are designed to accommodate an arrangement that yields a preferred sampling diversity of the scene (i.e. the pixels within one focal plane are collecting light from a slightly shifted field of view with respect to other focal planes within the imager array). This can be achieved through a variety of techniques. In several embodiments, sampling diversity is achieved by constructing the imager array so that the focal planes are relatively offset from the centers of their respective optical paths by different subpixel amounts through a relative subpixel shift in alignment between the focal planes and their respective lenses. In many embodiments, the optical field of view are “aimed” slightly differently by an angle that corresponds to a subpixel shift in the image (an amount less than the solid angle corresponding to a single pixel). In a number of embodiments, slight microlens shifts between the focal planes is utilized to alter the particular solid angle of light captured by the microlens (which redirects the light to the pixel) thus achieving a slight subpixel shift. In certain embodiments, the focal planes are constructed with pixels having subtle differences in pixel pitch between focal planes such that sampling diversity is provided irrespective of optical alignment tolerances. For example, a 4×4 imager array can be constructed with focal planes having pixels with length and width dimensions of size 2.0 μm, 2.05 μm, 2.1 μm, 2.15 μm and 2.2 μm. In other embodiments, any of a variety of pixel dimensions and/or techniques for improving sampling diversity amongst the focal planes within the imager array can be utilized as appropriate to a specific application.

### 5. Focal Plane Timing and Control Circuitry

Referring back to FIG. 1B, imager arrays in accordance with embodiments of the invention can include focal plane timing and control circuitry 154 that controls the reset and read-out (hence integration) of the pixels in each of the focal planes within the imager array. The ability of an imager array in accordance with embodiments of the invention to provide flexibility in read-out and integration time control can enable features including (but not limited to) high dynamic range imaging, high speed video and electronic image stabilization.

Traditional image sensors nominally employ two rolling address pointers into the pixel array, whose role is to indicate rows to receive pixel level charge transfer signals as well as “row select” signals for connecting a given row to the column lines enabling sampling of the sense node of the pixels. In many SOC image arrays in accordance with embodiments of the invention these two rolling address pointers are expanded to 2×M×N rolling address pointers. The pointer pairs for each focal plane can either address the same rows within each focal plane or can be offset from one another with respect to a global reference.

Focal plane timing and control address pointer circuitry in accordance with an embodiment of the invention is illustrated in FIG. 4H. The focal plane timing and control circuitry 400 includes a global row counter 402 and read pointer address logic circuitry 404 and reset pointer address logic circuitry 406 associated with each focal plane. The global row counter 402 is a global reference for sampling of rows of pixels. In a number of embodiments, the global row counter 402 counts from 0 to the total number of rows within a focal plane. In other embodiments, alternative global row counters are utilized as appropriate to the requirements of a specific application. The read pointer address logic circuitry 404 and the reset pointer address logic circuitry 406 translates the global row counter value to a physical address within the array as a function of settings such as read-out direction and windowing. In the illustrated embodiment, there are M×N read pointer and reset pointer address logic circuits. Row based timing shifts of each focal plane read-out and reset positions (FP_offset[x,y]) are provided to the read pointer address logic and reset pointer address logic circuits. These timing shifts can be stored in configuration registers within the imager array. The value of the timing shifts can be added to the global row counter value (modulo the total number of rows) before translation to physical addresses by the read pointer address logic and the reset pointer address logic circuits. In this way, each focal plane can be provided with a programmable timing offset. In several embodiments, the timing offsets are configured based upon different operational modes of the array camera.

### 6. System Power Management and Bias Generation

The system power management bias generation circuitry is configured to provide current and or voltage references to analog circuitry such as (but not limited to) the reference voltages against which an ADC would measure the signal to be converted against. In addition, system power management and bias generation circuitry in accordance with many embodiments of the invention can turn off the current/voltage references to certain circuits when they are not in use for power saving reasons. Additional power management techniques that can be implemented using power management circuitry in accordance with embodiments of the invention are discussed below.

### 6.1. Power Optimization

The master control block of an imager array in accordance with embodiments of the invention can manage the power consumption of the imager array. In many embodiments, the master control block reduces power consumption by “turning off” certain focal planes during modes of operation where the desired output resolution is less than the full performance of the device. In such modes, amplifiers, bias generators, ADCs and other clocked circuits associated with the focal planes that are not used are placed in a lower power state to minimize or eliminate static and dynamic power draw.

### 6.1.1. Preventing Carrier Migration During Imager Power Down

Despite a focal plane being in a powered down state, light is incident upon the pixels in its sub-array. Incident photons will continue to create charge carriers in the silicon substrate. If the pixels in a powered-down focal plane are left floating, the charge carriers will fill the pixel well and deplete the potential barrier making it unable to trap any further carriers. Excess carriers, created by the persistent photon flux will then be left to wander the substrate. If these excess carriers wander from an inactive focal plane into an active focal plane, and collect in the well of a pixel in an active focal plane, they would be erroneously measured to be photo-electrons that were generated within that pixel. The result can be the appearance of blooming around the periphery of the active imager caused by the tide of free carriers migrating into the active focal plane from the inactive neighbors.

To mitigate the migration of excess carriers from inactive focal planes, the photodiodes in the pixels of an inactive focal planes are connected to the power supply via transistor switches within each pixel such that the pixel well is held open to its maximum electrical potential. Holding the well open enables the photodiode to constantly collect carriers generated by the incident light and thus reduce the problem of carrier migration from an inactive imager. The transistors in each pixel are part of the normal pixel architecture i.e. the transfer gate, and it is the master control logic along with the row controllers that signal the transistors to hold the wells open.

### 6.1.2. Standby Mode

In many embodiments, reference pixels are used in the calibration of dark current and FPN. In several embodiments, the power management circuitry is configured to enable the powering down of the pixels in a focal plane in such a way that the reference pixels remain active. In several embodiments, this is achieved by powering the ASP during the readout of reference pixels but otherwise maintaining the ASP in a low power mode. In this way, the focal plane can be more rapidly activated by reducing the need to calibrate dark current and FPN when the focal plane is woken up. In many instances, calibration is performed with respect to dark current and FPN when the reference pixels are powered down during the low power state of the focal plane. In other embodiments, any of a variety of partial powering of circuitry can be utilized to reduce the current drawn by a focal plane and its associated peripheral circuitry in accordance with embodiments of the invention.

### 7. Focal Plane Data Collation and Framing Logic

Referring again to FIG. 1B, imager arrays in accordance with several embodiments of the invention include focal plane data collation and framing logic circuitry that is responsible for capturing the data from the focal planes and packaging the data into a container in accordance with a predetermined container format. In a number of embodiments, the circuitry also prepares the data for transmission by performing data transformations including but not limited to any bit reduction to the data (e.g. 10 bit to 8 bit conversion).

Although specific imager array architectures are described above, alternative imager array architectures can be used to implement. Imager arrays based upon requirements, including but not limited to, pixel size/performance, the optical system of the array camera, the silicon real-estate cost, and the manufacturing process used to fabricate the imager array in accordance with embodiments of the invention. In addition, imager arrays in accordance with embodiments of the invention can be implemented using any of a variety of shapes of pixels including but not limited to square pixels, rectangular pixels, hexagonal pixels, and a variety of pixel shapes. Accordingly, the scope of the invention should be determined not by the embodiments illustrated, but by the appended claims and equivalents.

What is claimed is:

1. An imager array configured to capture high dynamic range light field image data, the imager array comprising:
a plurality of focal planes, where each focal plane comprises a plurality of rows of pixels that also form a plurality of columns of pixels and each focal plane is contained within a region of the imager array that does not contain pixels from another focal plane;
read out circuitry configured to independently read out analog image information from pixels in the plurality of focal planes;
sampling circuitry configured to covert the analog image information read out from pixels in a given focal plane into high dynamic range digital image data, where the sampling circuitry for a given focal plane comprises:
an Analog Front End configured to apply a plurality of different amplification gains to analog image information read out from different pixels in the given focal plane to produce amplified high dynamic range analog image information; and
an Analog to Digital Converter configured to convert the amplified high dynamic range analog image information into high dynamic range digital image data; and
interface circuitry configured to transmit high dynamic range digital image data to an external device.

2. The imager array of claim 1, wherein:
the Analog Front End comprises at least two Analog Front End processing channels;
the sampling circuitry is configured so that a first Analog Front End processing channel applies a first predetermined amplification gain to analog image information read out from a pixel from the given focal plane; and
the sampling circuitry is configured so that a first Analog Front End processing channel applies a second predetermined amplification gain that is less than the first predetermined amplification gain to analog image information read out from a pixel from the given focal plane.

3. The imager array of claim 1, wherein the Analog Front End is configured to apply a plurality of different amplification gains to analog image information read out from different pixels in the given focal plane to produce amplified high dynamic range analog image information such that a higher amplification gain is applied to analog image information read out from a pixel that has an output value that satisfies a low light threshold and a lower amplification gain is applied to analog image information read out from a pixel that has an output value that does not satisfy the low light threshold.

4. The imager array of claim 1, wherein high dynamic range digital image data for a pixel in the given focal plane comprises:
a plurality of bits determined by digitizing amplified high dynamic range analog image information using the Analog to Digital Converter, where the amplified high dynamic range analog information is obtained by applying an amplification gain from the plurality of different amplification gains to analog image information read out from the pixel; and
at least one bit indicative of the amplification gain from the plurality of different amplification gains applied to the analog image information read out from the pixel to obtain the high dynamic range analog image data.

5. The imager array of claim 1, wherein the Analog Front End comprises:
a first analog amplifier configured to amplify analog image information using a first amplification gain; and
a second analog amplifier configured to amplify analog image information using a second amplification gain, where the second amplification gain is less than the first amplification gain.

6. The imager array of claim 5, further comprising control circuitry configured to provide analog image information read out from a pixel that has an output value that satisfies a low light threshold to the first analog amplifier and to provide analog image information read out from a pixel that has an output value that does not satisfy the low light threshold to the second analog amplifier.

7. The imager array of claim 6, wherein the control circuitry comprises at least one comparator configured to determine whether an output value of analog image information read out from a pixel is below a low light threshold value.

8. The imager array of claim 6, wherein high dynamic range digital image data for a pixel in the given focal plane comprises:
a plurality of bits determined by digitizing amplified high dynamic range analog image information using the Analog to Digital Converter, where the amplified high dynamic range analog information is obtained by applying an amplification gain from the plurality of different amplification gains to analog image information read out from the pixel; and
at least one bit indicative of the amplification gain from the plurality of different amplification gains applied to the analog image information read out from the pixel to obtain the high dynamic range analog image data.

9. The imager array of claim 1, wherein the Analog Front End comprises an analog amplifier configured to amplify analog image information using an amplification gain selected from the plurality of different amplification gains on a pixel by pixel basis by control circuitry.

10. The imager array of claim 9, wherein the control circuitry is configured to control the selection of an amplification gain from the plurality of different amplification gains for use by the analog amplifier in amplifying analog image information in a predetermined manner.

11. The imager array of claim 9, wherein:
the control circuitry is configured to select a first amplification gain from the plurality of different amplification gains for use by the analog amplifier when the analog image information read out from a pixel has an output value that satisfies a low light threshold; and
the control circuitry is configured to select a second amplification gain that is less than the first amplification gain from the plurality of different amplification gains for use by the analog amplifier when the analog image information read out from a pixel has an output value that does not satisfy a low light threshold.

12. The imager array of claim 11, wherein the control circuitry comprises at least one comparator configured to determine whether an output value of analog image information read out from a pixel is below a low light threshold value.

13. The imager array of claim 11, wherein high dynamic range digital image data for a pixel in the given focal plane comprises:
a plurality of bits determined by digitizing amplified high dynamic range analog image information using the Analog to Digital Converter, where the amplified high dynamic range analog information is obtained by applying an amplification gain from the plurality of different amplification gains to analog image information read out from the pixel; and
at least one bit indicative of the amplification gain from the plurality of different amplification gains applied to the analog image information read out from the pixel to obtain the high dynamic range analog image data.

14. The imager array of claim 1, wherein the pixels of the given focal plane have the same conversion gain.

15. The imager array of claim 1, wherein the pixels of the given focal plane have different conversion gains.

16. The imager array of claim 1, wherein the Analog Front End is dedicated to the given focal plane.

17. The imager array of claim 1, wherein the Analog Front End is shared by the given focal plane and at least one additional focal plane.

18. The imager array of claim 1, wherein the Analog Front End comprises a plurality of Analog Front End processing channels and the sampling circuitry is configured so that each Analog Front End processing channel applies an amplification gain selected from the plurality of different amplification gains to analog image information read out from a subset of pixels from the given focal plane.

19. The imager array of claim 1, wherein the Analog Front End comprises a plurality of Analog Front End processing channels and the sampling circuitry is configured so that each Analog Front End processing channel applies a different amplification gain from the plurality of different amplification gains to analog image information read out from a pixel from the given focal plane.

20. The imager array of claim 19, wherein each Analog Front End processing channel includes a dedicated ADC.

21. The imager array of claim 1, wherein the Analog to Digital Converter (ADC) is configured to convert the amplified high dynamic range analog image information into high dynamic range digital image data by quantizing the amplified high dynamic range analog image information.

22. The imager array of claim 1, further comprising:
calibration circuitry;
wherein the Analog Front End is configured to apply the plurality of different amplification gains to calibration information read out from at least one black pixel;
wherein the calibration circuitry can determine a black level offset level for each of the plurality of different amplification gains applied by the Analog Front End to analog image information read out from active pixels in the given focal plane; and
wherein the calibration circuitry is configured to apply a black level offset to the amplified high dynamic range analog image information prior to conversion to high dynamic range digital image data by the Analog to Digital Converter.

23. The imager array of claim 1, further comprising:
calibration circuitry;
wherein the Analog Front End is configured to apply the plurality of different amplification gains to calibration information read out from at least one black pixel;
wherein the calibration circuitry can determine a black level offset level for each of the plurality of different amplification gains applied by the Analog Front End to analog image information read out from active pixels in the given focal plane; and
wherein the calibration circuitry is configured to apply a black level offset to the high dynamic range digital image data output by the Analog to Digital Converter.

24. An imager array configured to capture light field image data and high dynamic range light field image data, the imager array comprising:
a plurality of focal planes, where each focal plane comprises a plurality of rows of pixels that also form a plurality of columns of pixels and each focal plane is contained within a region of the imager array that does not contain pixels from another focal plane;
read out circuitry configured to independently read out analog image information from pixels in the plurality of focal planes;
sampling circuitry configured to covert the analog image information read out from pixels in a given focal plane into digital image data, where the sampling circuitry for a given focal plane comprises:
an Analog Front End (AFE) configured to apply an amplification gain selected from a plurality of different amplification gains to analog image information read out from different pixels in the given focal plane to produce amplified analog image information;
an Analog to Digital Converter (ADC) configured to convert the amplified analog image information into digital image data; and
control circuitry configured to configure the sampling circuitry in a mode selected from a group consisting of at least a standard image capture mode and a high dynamic range image capture mode in response to a configuration command; and
interface circuitry configured to:
transmit digital image data to an external device;
receive a configuration command from an external device; and
provide a configuration command received from an external device to the control circuitry;
wherein the sampling circuitry is configured so that the Analog Front End applies the same amplification gain to the analog image information read out from the pixels in the given focal plane in the standard image capture mode; and
wherein the sampling circuitry is configured so that the Analog Front End applies different amplification gains selected from the plurality of different amplification gains to the analog image information read out from the pixels in the given focal plane in the high dynamic range image capture mode.

25. The imager array of claim 24, wherein the sampling circuitry is configured so that the AFE applies different amplification gains selected from the plurality of different amplification gains to the analog image information read out from the pixels in the given focal plane in the high dynamic range image capture mode so that a higher amplification gain is applied to analog image information read out from a pixel that has an output value that satisfies a low light threshold and a lower amplification gain is applied to analog image information read out from a pixel that has an output value that does not satisfy a low light threshold.

26. The imager array of claim 25, wherein the digital image data in the high dynamic range mode is high dynamic range digital image data and high dynamic range digital image data for a pixel in the given focal plane comprises:
a plurality of bits determined by digitizing amplified high dynamic range analog image information using the Analog to Digital Converter, where the amplified high dynamic range analog information is obtained by applying an amplification gain from the plurality of different amplification gains to analog image information read out from the pixel; and
at least one bit indicative of the amplification gain from the plurality of different amplification gains applied to the analog image information read out from the pixel to obtain the high dynamic range analog image data.

27. A method of capturing high dynamic range light field image data, comprising:
capturing analog image information for a light field using a plurality of active focal planes in a camera module comprising an imager array and an optic array of lens stacks,
where each focal plane comprises a plurality of rows of pixels that also form a plurality of columns of pixels and each focal plane is contained within a region of the imager array that does not contain pixels from another focal plane, and
where the imager array further includes:
read out circuitry configured to independently read out analog image information from pixels in the plurality of focal planes;
sampling circuitry configured to covert the analog image information read out from pixels in a given focal plane into high dynamic range digital image data, where the sampling circuitry for a given focal plane comprises:
an Analog Front End configured to apply a plurality of different amplification gains to analog image information read out from different pixels in the given focal plane to produce amplified high dynamic range analog image information; and
an Analog to Digital Converter configured to convert the amplified high dynamic range analog image information into high dynamic range digital image data; and
where an image is formed on each active focal planes by a separate lens stack in said optic array of lens stacks;
selecting a plurality of pixels from at least one row and at least one column in a given focal plane from the plurality of active focal planes using the read out circuitry and reading out analog image information from the selected pixels in the given focal plane;
amplifying the analog image information read out from the selected pixels in the given focal plane using amplification gains selected from the plurality of different amplification gains using the Analog Front End to produce amplified high dynamic range analog image information for the selected pixel in the given focal plane;
converting the amplified high dynamic range analog image information for the selected pixels in the given focal plane into high dynamic range digital image data for the selected pixels in the given focal plane using the Analog to Digital Converter; and
transmitting from the camera module image data including the high dynamic range digital image data.

28. The method of claim 27, wherein amplifying the analog image information read out from the selected pixels in the given focal plane using amplification gains selected from the plurality of different amplification gains using the Analog Front End to produce amplified high dynamic range analog image information for the selected pixel in the given focal plane further comprises:
applying a first amplification gain from the plurality of different amplification gains to analog image information read out from a pixel; and
applying a second amplification gain that is less than the first amplification gain to analog image information read out from a pixel.

29. The method of claim 27, wherein amplifying the analog image information read out from the selected pixels in the given focal plane using amplification gains selected from the plurality of different amplification gains using the Analog Front End to produce amplified high dynamic range analog image information for the selected pixel in the given focal plane further comprises:
applying a first amplification gain from the plurality of different amplification gains to analog image information read out from a pixel that has an output value that satisfies a low light threshold; and
applying a second amplification gain that is less than the first amplification gain to analog image information read out from a pixel that has an output value that does not satisfy the low light threshold.

30. The imager array of claim 29, wherein converting the amplified high dynamic range analog image information for the selected pixels in the given focal plane into high dynamic range digital image data for the selected pixels in the given focal plane using the Analog to Digital Converter further comprises generating high dynamic range digital data for a selected pixel by:
generating a plurality of image data bits determined by digitizing amplified high dynamic range analog image information using the Analog to Digital Converter, where the amplified high dynamic range analog information is obtained by applying an amplification gain from the plurality of different amplification gains to analog image information read out from the selected pixel; and
generating at least one bit of additional data, where the at least one bit of additional data is indicative of the amplification gain from the plurality of different amplification gains applied to the analog image information read out from the selected pixel to obtain the high dynamic range analog image data; and
combining the plurality of image data bits and the at least one bit of additional data to create high dynamic range digital image data for the selected pixel.
